(19) United States
(12) Patent Application Publication
(10) Pub. No.: US 2024/0301124 A1
(43) Pub. Date: Sep. 12, 2024

(54) POLYUREA COPOLYMER

(71) Applicant: BASF SE, Ludwigshafen am Rhein (DE)

(72) Inventors: Sandra Gloria KOENIG, Ludwigshafen am Rhein (DE); Michael ZEILINGER, Ludwigshafen am Rhein (DE); Dag WIEBELHAUS, Ludwigshafen am Rhein (DE); Aggeliki QUELL, Ludwigshafen am Rhein (DE)

(21) Appl. No.: 18/280,690

(22) PCT Filed: Mar. 3, 2022
(86) PCT No.: PCT/EP2022/055360

§ 371 Date: Sep. 7, 2023

(30) Foreign Application Priority Data
Mar. 10, 2021 (EP) 21161751.9

(51) Int. Cl. C08G 18/83

(52) U.S. Cl. CPC C08G 18/833

(57) ABSTRACT

Polyurea Copolymer Presently claimed invention is directed to a process for treating polyurethane, polyurea and/or polyurethane-polyurea copolymers comprising the steps of: a) providing at least one component (A) selected from the group consisting of polyurethane, polyurea and polyurethane-polyurea copolymers; and b) providing at least one secondary amine of formula (B); c) reacting the at least one component (A) with the at least one secondary amine of formula (B) to obtain a first reaction product (D); d) proving at least one isocyanate component (C); e) reacting the first reaction product (D) obtained in step c. with the at least one isocyanate component (C) to obtain a product, wherein the at least one isocyanate component (C) has an average NCO functionality of ≥2.0.

### FIELD OF INVENTION

The presently claimed invention is directed to a process for treating polyurethane, polyurea and/or polyurethane-polyurea copolymers.

### BACKGROUND OF INVENTION

Polyurethane and polyurea polymer compositions are used in a wide variety of products including fibers, sporting goods, toys, coatings, sealants and adhesives, films and linings, and flexible and rigid foams. polyurethane and polyurea can either be thermoplastic or thermosetting polymers. As such polyurethane polymers (PU), polyurea polymers (PA) or polyurethane-polyurea copolymers (PU/PA) are used in a wide variety of products. Depending on the desired properties of the final product, PU, PA or PA/PU copolymers are prepared as thermoplastic or thermosetting polymers.

Polyurethanes are produced by the reaction of a multi-functional isocyanate with a polyol in the presence of a catalyst and other additives. Often, the so obtained polyurethanes still contain reactive NCO groups which can be reacted with chain extenders and/or curatives to tweak the properties of the final polyurethane. Polyurethanes with reactive NCO groups are often referred to as polyurethane prepolymers.

Chain extenders are low molecular weight (short chain) diols and diamines. Chain extenders align themselves with the stiff and largely immobile hard segments in polyurethanes. Curatives are high functionality polyols and amines, with functionalities greater than 2, which act like crosslinkers between the coiled soft segments and the hard segments of the polyurethane. The interaction between the soft and hard segments in a polyurethane contributes to the desirable physical properties such as elasticity, tensile strength, tear resistance, and elongation.

The soft segment(s) is usually composed of a polyether and/or polyester polyol which is incorporated into the polyurethane backbone. The soft segment(s) contributes for example to the elasticity of the respective polyurethane.

The hard segment(s) is usually composed of a diisocyanate and/or a chain extender which are incorporated into the polyurethane backbone. The hard segment(s) contributes for example to the tensile strength and to the rigidity of the respective polyurethane, for example by providing cross-linking points.

In general, polyurea compositions contain urea linkages formed by reacting an isocyanate group (—N═C═O) with an amine group (—NHR or —NH₂). Polyurethanes are produced by the reaction of a multi-functional isocyanate with a polyamine in the presence of a catalyst and other additives. Often, the so obtained polyurea still contain reactive NCO groups which can be reacted with chain extenders and/or curatives to tweak the properties of the final polyurea. Polyurea with reactive NCO groups are often referred to as polyurea prepolymers.

Chain extenders and curatives which are used in combination with polyurea prepolymers are generally the same as these used in combination with polyurethane prepolymers.

Although polyureas and polyurethanes are often regarded as different polymers, it is also possible that one polymer contains both urea and urethane linkages in its backbone. Such polymers are referred herein as polyurethane-polyurea copolymers.

For example, polyurethane-polyurea copolymer may be produced when a polyurea prepolymer is reacted with a hydroxyl-terminated curative and/or chain extender.

In industrial applications, polyurethane-, polyurea polymers or polyurethane-polyurea copolymer are typically synthesized by the condensation reaction of a polyisocyanate, such as diphenylmethane diisocyanate, and a resin with free hydroxyl groups and/or a resin with free amine groups. Resins may also include linear polyesters, polyethers containing hydroxyl groups, amine-substituted aromatics, and aliphatic amines. The resulting polymers provides resistance to abrasion, weathering, and organic solvents and may be utilized in a variety of industrial applications as a sealant, caulking agent, or lining, for example.

As the prevalence of polyurethane polymers, the polyurea polymers and the polyurea-polyurethane copolymers increases and therewith of the articles comprising any of these polymers. Thus, the potential for an adverse environmental burden also increases. Typically, after use, these articles are disposed of in landfills and may create an adverse environmental burden. These articles may contain PU, PA and PU/PA in the form of a trimming, a slab, or a formed part (wherein the formed part was actually used for its intended purpose or disposed of prior to use for a variety of reasons), and may be disposed of after off-specification production or after an end use. Due to the potentially adverse environmental burden resulting from the disposal of these articles, it would be advantageous to recycle/process these articles.

Various methods of recycling/processing polyurethane polymers and polyurea polymer are known in the prior art. These recycling/processing methods generally include mechanical recycling, in which especially the polyurethane polymers and the polyurea polymers are reused in its polymer form, and chemical recycling, in which the polyurethane polymers and the polyurea polymer are broken down into various chemical constituents. General examples of mechanical recycling of the polyurethane retain the physical properties similar to the virgin polyurethanes, polyurea and polyurethane-polyurea polymers such as tensile strength, young's modulus etc. Another object of the presently claimed invention is to provide a “solventless recycling” or “zero-waste recycling” process for polyurethanes, polyurea and polyurethane-polyurea polymers. The “solventless recycling” or the “zero-waste recycling” process means, a process in which no addition of additional components is needed or if any additional component has to be added this component can remain in the mixture and can be reused for next reaction or can remain a part of the product.

### SUMMARY OF INVENTION

The object is achieved by treating polyurethane, polyurea and/or polyurethane-polyurea copolymers with at least one secondary amine (B) and at least one polyisocyanate component (C).

Accordingly, in a first aspect, the presently claimed invention is directed to a process for treating polyurethane, polyurea and/or polyurethane-polyurea copolymers comprising the steps of:
a. providing at least one component (A) selected from the group consisting of polyurethane polymers, polyurea polymers and polyurethane-polyurea copolymers; and
b. providing at least one secondary amine of formula (B)

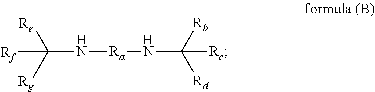

wherein Rₐ is selected from the group consisting of substituted or unsubstituted, linear or branched C₁-C₃₀ alkylene, substituted or unsubstituted, linear or branched 2- to 30-membered heteroalkylene,
substituted or unsubstituted, linear or branched C₂-C₃₀ alkenylene, substituted or unsubstituted, linear or branched 3- to 30-membered heteroalkenylene, substituted or unsubstituted C₅-C₃₀ cycloalkylene,
substituted or unsubstituted 5- to 30-membered heterocycloalkylene, substituted or unsubstituted C₅-C₃₀ cycloalkenylene, substituted or unsubstituted 5- to 30-membered heterocycloalkenylene, substituted or unsubstituted C₆-C₃₀ arylene, substituted or unsubstituted 5- to 30-membered heteroarylene, substituted or unsubstituted C₁-C₃₀ alkylene C₅-C₃₀ cycloalkylene, substituted or unsubstituted C₅-C₃₀ cycloalkylene C₁-C₃₀ alkylene C₅-C₃₀ cycloalkylene, substituted or unsubstituted C₁-C₃₀ alkylene 5- to 30-membered heterocycloalkylene, substituted or unsubstituted C₁-C₃₀ alkylene C₅-C₃₀ cycloalkenylene, substituted or unsubstituted C₁-C₃₀ alkylene 5- to 30-membered heterocycloalkenylene,
substituted or unsubstituted C₁-C₃₀ alkylene C₆-C₃₀ arylene, substituted or unsubstituted C₆-C₃₀ arylene C₁-C₃₀ alkylene C₆-C₃₀ arylene, substituted or unsubstituted C₁-C₃₀ alkylene 5- to 30-membered heteroarylene, substituted or unsubstituted C₂-C₃₀ alkenylene C₅-C₃₀ cycloalkylene, substituted or unsubstituted C₂-C₃₀ alkenylene 5- to 30-membered heterocycloalkylene, substituted or unsubstituted C₂-C₃₀ alkenylene C₅-C₃₀ cycloalkenylene, substituted or unsubstituted C₂-C₃₀ alkenylene 5- to 30-membered heterocycloalkenylene, substituted or unsubstituted C₂-C₃₀ alkenylene C₆-C₃₀ arylene, and substituted or unsubstituted C₂-C₃₀ alkenylene 5- to 30-membered heteroarylene,
R_{b}, R_{c}, R_{d}, Rₑ, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, unsaturated or aromatic, unsubstituted or substituted 5- to 30-membered carbocyclic ring that contains 0, 1, 2 or 3 heteroatom(s) selected from O, N or S as ring member(s);
c. reacting the at least one component (A) with the at least one secondary amine of formula (B) to obtain a first reaction product (D);
d. proving at least one polyisocyanate component (C);
e. reacting the first reaction product (D) obtained in step c. with the at least one polyisocyanate component (C) to obtain a product,
   wherein the at least one polyisocyanate component (C) has an average NCO functionality of ≥2.0.

Second aspects of the presently claimed invention is to provide processed polyurethane, polyurea and/or polyurethane-polyurea copolymers. Processed polyurethane, polyurea and/or polyurethane-polyurea copolymers refers to polyurethane, polyurea and/or polyurethane-polyurea copolymers which were obtained according to the first aspect.

The third aspects of the presently claimed invention is to provide an article comprising processed polyurethane, polyurea and/or polyurethane-polyurea copolymers.

The fourth aspects of the presently claimed invention is to provide a process for reshaping a copolymer comprising at least the steps of:
a. applying pressure and heat to the processed polyurethane, polyurea and/or polyurethane-polyurea copolymers; and
b. shaping the copolymer of step a).

### DETAILED DECEPTION OF INVENTION

Before the present compositions and formulations of the presently claimed invention are described, it is to be understood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms ‘first’, ‘second’, ‘third’ or ‘a’, ‘b’, ‘c’, etc. and the like in the description and in the claims, are used for distinguishing between similar elements and not necessarily for describing a sequential or chronological order. It is to be understood that the terms so used are interchangeable under appropriate circumstances and that the embodiments of the presently claimed invention described herein are capable of operation in other sequences than described or illustrated herein. In case the terms ‘first’, ‘second’, ‘third’ or ‘(A)’, ‘(B)’ and ‘(C)’ or ‘(a)’, ‘(b)’, ‘(c)’, ‘(d)’, ‘i’, ‘ii’ etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

Furthermore, the ranges defined throughout the specification include the end values as well i.e. a range of 1 to 10 implies that both 1 and 10 are included in the range. For the avoidance of doubt, applicant shall be entitled to any equivalents according to applicable law.

In the following passages, different aspects of the presently claimed invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to ‘one embodiment’ or ‘an embodiment’ means that a particular feature, structure or characteristic described in connection with the embodiment is included in at least one embodiment of the presently claimed invention. Thus, appearances of the phrases ‘in one embodiment’ or ‘in an embodiment’ in various places throughout this specification are not necessarily all referring to the same embodiment, but may.

Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the presently claimed invention, and form different embodiments, as would be understood by those in the art. For example, in the appended claims, any of the claimed embodiments can be used in any combination.

In a first embodiment, the presently claimed invention is directed to a process for treating polyurethane, polyurea and/or polyurethane-polyurea copolymers comprising the steps of:
a. providing at least one component (A) selected from the group consisting of polyurethane, polyurea and polyurethane-polyurea copolymers; and
b. providing at least one secondary amine of formula (B)

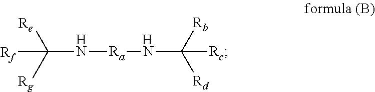

wherein Rₐ is selected from the group consisting of substituted or unsubstituted, linear or branched C₁-C₃₀ alkylene, substituted or unsubstituted, linear or branched 2- to 30-membered heteroalkylene,
substituted or unsubstituted, linear or branched C₂-C₃₀ alkenylene, substituted or unsubstituted, linear or branched 3- to 30-membered heteroalkenylene, substituted or unsubstituted C₅-C₃₀ cycloalkylene,
substituted or unsubstituted 5- to 30-membered heterocycloalkylene, substituted or unsubstituted C₅-C₃₀ cycloalkenylene, substituted or unsubstituted 5- to 30-membered heterocycloalkenylene, substituted or unsubstituted C₆-C₃₀ arylene, substituted or unsubstituted 5- to 30-membered heteroarylene, substituted or unsubstituted C₁-C₃₀ alkylene C₅-C₃₀ cycloalkylene, substituted or unsubstituted C₅-C₃₀ cycloalkylene C₁-C₃₀ alkylene C₅-C₃₀ cycloalkylene, substituted or unsubstituted C₁-C₃₀ alkylene 5- to 30-membered heterocycloalkylene, substituted or unsubstituted C₁-C₃₀ alkylene C₅-C₃₀ cycloalkenylene,
substituted or unsubstituted C₁-C₃₀ alkylene 5- to 30-membered heterocycloalkenylene, substituted or unsubstituted C₁-C₃₀ alkylene C₆-C₃₀ arylene, substituted or unsubstituted C₆-C₃₀ arylene C₁-C₃₀ alkylene C₆-C₃₀ arylene, substituted or unsubstituted C₁-C₃₀ alkylene 5- to 30-membered heteroarylene, substituted or unsubstituted C₂-C₃₀ alkenylene C₅-C₃₀ cycloalkylene, substituted or unsubstituted C₂-C₃₀ alkenylene 5- to 30-membered heterocycloalkylene, substituted or unsubstituted C₂-C₃₀ alkenylene C₅-C₃₀ cycloalkenylene, substituted or unsubstituted C₂-C₃₀ alkenylene 5- to 30-membered heterocycloalkenylene, substituted or unsubstituted C₂-C₃₀ alkenylene C₆-C₃₀ arylene, and substituted or unsubstituted C₂-C₃₀ alkenylene 5- to 30-membered heteroarylene,
R_{b}, R_{c}, R_{d}, Rₑ, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, unsaturated or aromatic, unsubstituted or substituted 5- to 30-membered carbocyclic ring that contains 0, 1, 2 or 3 heteroatom(s) selected from O, N or S as ring member(s);
c. reacting the at least one component (A) with the at least one secondary amine of formula (B) to obtain a first reaction product (D);
d. proving at least one polyisocyanate component (C);
e. reacting the first reaction product (D) obtained in step c. with the at least one polyisocyanate component (C) to obtain a product,
   wherein the at least one polyisocyanate component (C) has an average NCO functionality of ≥2.0.

Preferably the presently claimed invention is directed to a process for treating polyurethane, polyurea and/or polyurethane-polyurea copolymers comprising the steps of:
a. providing at least one component (A) selected from the group consisting of polyurethane, polyurea and polyurethane-polyurea copolymers; and
b. providing at least one secondary amine of formula (B)

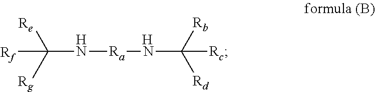

wherein Rₐ is selected from the group consisting of substituted or unsubstituted, linear or branched C₁-C₃₀ alkylene, substituted or unsubstituted, linear or branched C₂-C₃₀ alkenylene, substituted or unsubstituted C₅-C₃₀ cycloalkylene, substituted or unsubstituted 5- to 30-membered heterocycloalkylene, substituted or unsubstituted C₅-C₃₀ cycloalkenylene, substituted or unsubstituted C₆-C₃₀ arylene, substituted or unsubstituted 5- to 30-membered heteroarylene, substituted or unsubstituted C₁-C₃₀ alkylene C₅-C₃₀ cycloalkylene, substituted or unsubstituted C₅-C₃₀ cycloalkylene C₁-C₃₀ alkylene C₅-C₃₀ cycloalkylene, substituted or unsubstituted C₁-C₃₀ alkylene C₅-C₃₀ cycloalkenylene, substituted or unsubstituted C₁-C₃₀ alkylene C₆-C₃₀ arylene, substituted or unsubstituted C₆-C₃₀ arylene C₁-C₃₀ alkylene C₆-C₃₀ arylene, substituted or unsubstituted C₁-C₃₀ alkylene 5- to 30-membered heteroarylene, substituted or unsubstituted C₂-C₃₀ alkenylene C₅-C₃₀ cycloalkenylene, substituted or unsubstituted C₂-C₃₀ alkenylene C₆-C₃₀ arylene, and substituted or unsubstituted C₂-C₃₀ alkenylene 5- to 30-membered heteroarylene,
R_{b}, R_{c}, R_{d}, Rₑ, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, unsaturated or aromatic, unsubstituted or substituted 5- to 30-membered carbocyclic ring that contains 0, 1, 2 or 3 heteroatom(s) selected from O, N and S as ring member(s);
c. reacting the at least one component (A) with the at least one secondary amine of formula (B) to obtain a first reaction product (D);
d. proving at least one polyisocyanate component (C);
e. reacting the first reaction product (D) obtained in step c. with the at least one polyisocyanate component (C) to obtain a product,
   wherein the at least one polyisocyanate component (C) has an average NCO functionality of ≥2.0.

More preferably the presently claimed invention is directed to a process for treating polyurethane, polyurea and/or polyurethane-polyurea copolymers comprising the steps of:
a. providing at least one component (A) selected from the group consisting of polyurethane, polyurea and polyurethane-polyurea copolymers; and
b. providing at least one secondary amine of formula (B)

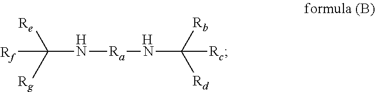

wherein Rₐ is selected from the group consisting of substituted or unsubstituted, linear or branched C₁-C₃₀ alkylene, substituted or unsubstituted, linear or branched C₂-C₃₀ alkenylene, substituted or unsubstituted C₅-C₃₀ cycloalkylene, substituted or unsubstituted 5- to 30-membered heterocycloalkylene, substituted or unsubstituted C₅-C₃₀ cycloalkenylene, substituted or unsubstituted C₆-C₃₀ arylene, substituted or unsubstituted 5- to 30-membered heteroarylene, substituted or unsubstituted C₁-C₃₀ alkylene C₅-C₃₀ cycloalkylene, substituted or unsubstituted C₅-C₃₀ cycloalkylene C₁-C₃₀ alkylene C₅-C₃₀ cycloalkylene, substituted or unsubstituted C₁-C₃₀ alkylene C₅-C₃₀ cycloalkenylene, substituted or unsubstituted C₁-C₃₀ alkylene C₆-C₃₀ arylene, substituted or unsubstituted C₆-C₃₀ arylene C₁-C₃₀ alkylene C₆-C₃₀ arylene, substituted or unsubstituted C₁-C₃₀ alkylene 5- to 30-membered heteroarylene, substituted or unsubstituted C₂-C₃₀ alkenylene C₅-C₃₀ cycloalkenylene and substituted or unsubstituted C₂-C₃₀ alkenylene C₆-C₃₀ arylene, and
R_{b}, R_{c}, R_{d}, Rₑ, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₃₀ cycloalkyl, substituted or unsubstituted C₅-C₃₀ cycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, unsaturated or aromatic, unsubstituted or substituted 5- to 30-membered carbocyclic ring that contains 0, 1, 2 or 3 heteroatom(s) selected from O, N and S as ring member(s);
c. reacting the at least one component (A) with the at least one secondary amine of formula (B) to obtain a first reaction product (D);
d. proving at least one polyisocyanate component (C);
e. reacting the first reaction product (D) obtained in step c. with the at least one polyisocyanate component (C) to obtain a product,
   wherein the at least one polyisocyanate component (C) has an average NCO functionality of ≥2.0.

Even more preferably the presently claimed invention is directed to a process for treating polyurethane, polyurea and/or polyurethane-polyurea copolymers comprising the steps of:
a. providing at least one component (A) selected from the group consisting of polyurethane, polyurea and polyurethane-polyurea copolymers; and
b. providing at least one secondary amine of formula (B)

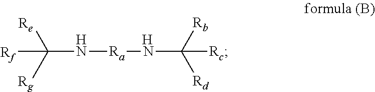

wherein Rₐ is selected from the group consisting of substituted or unsubstituted, linear or branched C₁-C₃₀ alkylene, substituted or unsubstituted C₅-C₃₀ cycloalkylene, substituted or unsubstituted 5- to 30-membered heterocycloalkylene, substituted or unsubstituted C₆-C₃₀ arylene, substituted or unsubstituted 5- to 30-membered heteroarylene, substituted or unsubstituted C₁-C₃₀ alkylene C₅-C₃₀ cycloalkylene, substituted or unsubstituted C₅-C₃₀ cycloalkylene C₁-C₃₀ alkylene C₅-C₃₀ cycloalkylene, substituted or unsubstituted C₁-C₃₀ alkylene C₆-C₃₀ arylene, substituted or unsubstituted C₆-C₃₀ arylene C₁-C₃₀ alkylene C₆-C₃₀ arylene, substituted or unsubstituted C₁-C₃₀ alkylene 5- to 30-membered heteroarylene and substituted or unsubstituted C₂-C₃₀ alkenylene C₆-C₃₀ arylene, and
R_{b}, R_{c}, R_{d}, Rₑ, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₃₀ cycloalkyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₆-C₃₀ aryl and substituted or unsubstituted C₁-C₁₀ alkylene 5- to 30-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, unsaturated or aromatic, unsubstituted or substituted 5- to 30-membered carbocyclic ring that contains 0, 1, 2 or 3 heteroatom(s) selected from O, N and S as ring member(s);
c. reacting the at least one component (A) with the at least one secondary amine of formula (B) to obtain a first reaction product (D);
d. proving at least one polyisocyanate component (C);
e. reacting the first reaction product (D) obtained in step c. with the at least one polyisocyanate component (C) to obtain a product,
   wherein the at least one polyisocyanate component (C) has an average NCO functionality of ≥2.0.

In Particularly preferred embodiment the presently claimed invention is directed to a process for treating polyurethane, polyurea and/or polyurethane-polyurea copolymers comprising the steps of:
a. providing at least one component (A) selected from the group consisting of polyurethane, polyurea and polyurethane-polyurea copolymers; and
b. providing at least one secondary amine of formula (B)

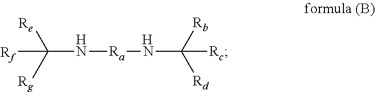

wherein Rₐ is selected from the group consisting of substituted or unsubstituted, linear or branched C₁-C₃₀ alkylene, substituted or unsubstituted C₅-C₃₀ cycloalkylene, substituted or unsubstituted 5- to 30-membered heterocycloalkylene, substituted or unsubstituted C₆-C₃₀ arylene, substituted or unsubstituted C₁-C₃₀ alkylene C₅-C₃₀ cycloalkylene, substituted or unsubstituted C₅-C₃₀ cycloalkylene C₁-C₃₀ alkylene C₅-C₃₀ cycloalkylene, substituted or unsubstituted C₁-C₃₀ alkylene C₆-C₃₀ arylene and substituted or unsubstituted C₆-C₃₀ arylene C₁-C₃₀ alkylene C₆-C₃₀ arylene,
R_{b}, R_{c}, R_{d}, Rₑ, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₃₀ cycloalkyl and substituted or unsubstituted C₆-C₃₀ aryl
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, unsaturated or aromatic, unsubstituted or substituted 5- to 30-membered carbocyclic ring that contains 0, 1, 2 or 3 heteroatom(s) selected from O, N and S as ring member(s);
c. reacting the at least one component (A) with the at least one secondary amine of formula (B) to obtain a first reaction product (D);
d. proving at least one polyisocyanate component (C);
e. reacting the first reaction product (D) obtained in step c. with the at least one polyisocyanate component (C) to obtain a product,
   wherein the at least one polyisocyanate component (C) has an average NCO functionality of ≥2.0.

### Step a.

Within the presently claimed invention the term “polyurethanepolymers” refers to polyurethane polymers that have previously been formed (i.e., are pre-formed) as the reaction product of an isocyanate component (alternatively referred to herein as an isocyanate) and an isocyanate-reactive component. These polyurethane polymers may be used in the formation of objects and articles. Preferably, the polyurethane polymer to be recycled is in the form of comminuted polyurethane polymer. Comminuted polyurethane polymer refer to polyurethane polymer that is in powder form, or otherwise are in the form of minute particles or fragments.

In another preferred embodiment, when the pre-formed polyurethane polymer is in the form of a foam (i.e., is a pre-formed polyurethane foam article), the isocyanate and the isocyanate-reactive component are reacted in the presence of a blowing agent to form the pre-formed polyurethane foam. The blowing agent may be a physical blowing agent, a chemical blowing agent, or a combination of a physical blowing agent and chemical blowing agent.

In another preferred embodiment, the pre-formed recycled polyurethane foam used in the subject application can be a “flexible polyurethane foam” or a “rigid polyurethane foam.” As used herein, the terminology “flexible polyurethane foam” denotes a particular class of polyurethane foam and stands in contrast to “rigid polyurethane foam.” Flexible polyurethane foam is generally porous, having open cells, whereas rigid polyurethane foam is generally non-porous, having closed cells and no rubber-like characteristics. In particular, flexible polyurethane foam is a flexible cellular product which will not rupture when a specimen 200 mm by 25 mm by 25 mm is bent around a 25-mm diameter mandrel at a uniform rate of 1 lap in 5 seconds at a temperature between 18 and 29 degrees Celsius, as defined by ASTM D3574-03.

In another preferred embodiment, the polyurethane foam used in the subject application can be in the form of a “semi-rigid flexible polyurethane foam” (SRU), which includes attributes of both a “flexible polyurethane foam” and “rigid polyurethane foam” as described above.

In another preferred embodiment, the polyurethane foamed that is particularly suitable for use in the presently claimed invention is a microcellular polyurethane (MCU) foam. It is to be appreciated that the MCU foam may also include additional components other than the MCU.

In another preferred embodiment, the MCU foam may be provided in a non-powder form (i.e., a non-comminuted form) and pulverized to produce the comminuted MCU foam. More preferably, the MCU foam may be obtained from pre-formed MCU foam object or material may be obtained from virgin material. For purposes of the presently claimed invention, the MCU foam may be obtained from the pre-formed MCU foam or the virgin material, or a combination of both the pre-formed MCU foam and the virgin material.

In another preferred embodiment, the pre-formed MCU foam as described above is distinguished from the virgin material in that the pre-formed MCU foam is initially formed for another use. More preferably, the MCU foam originates as a slab, a trimming, or a formed article or is procured from a waste stream of a manufacturing process. Further, the MCU foam may include a combination of different MCU foams, as described in further detail below, since the MCU foam may be procured from multiple sources. In contrast, the virgin material is specifically created to produce an MCU foam and is procured from a product stream before being optionally pulverized to form the comminuted MCU foam. Since the virgin material is prepared solely for use to form the isocyanate prepolymers and polyurethane elastomers of the presently claimed invention (described below), the virgin material preferably comprises only one type of MCU foam.

In another preferred embodiment, MCU foams are formed through a two-step process, as known in the art. First, an isocyanate prepolymer is formed through an exothermic reaction of a hydroxyl-functional polymer containing two or more hydroxyl groups and a diisocyanate. Next, the isocyanate prepolymer reacts with water to create a carbon dioxide offgas. A release of the carbon dioxide offgas creates a cellular structure. The cellular structure is then cured, and thereby completes the formation of the MCU foam.

In another preferred embodiment, the MCU foam may include methyldiphenyl diisocyanate-based foam, naphthalene diisocyanate-based foam, tolidine diisocyanate-based foam, and combinations thereof. For example, as alluded to above, when the MCU foam is virgin material or from a single source, the MCU foam is typically solely methyldiphenyl diisocyanate-based foam or naphthalene diisocyanate-based foam or tolidine diisocyanate-based foam. In another preferred embodiment, the MCU foam may be a combination of methyldiphenyl diisocyanate-based foam, naphthalene diisocyanate-based foam, and tolidine diisocyanate-based foam. After pulverization, the particle size of the comminuted polyurethane polymer based on the MCU foam is preferably from 0.5 to 10 mm. preferably, as set forth above, the comminuted polyurethane polymer may be provided as a pre-made product, in which case the above steps are unnecessary. The resulting comminuted polyurethane polymer based on the MCU foam (i.e., the comminuted MCU foam) preferably has a melt temperature of at least 100-350° C. (degrees Celsius), more preferably at least 250° C.

In another preferred embodiment, after the comminuted polyurethane polymer based on the MCU foam is provided and prior to use in the presently claimed invention, substantially all of the moisture may be eliminated from the comminuted polyurethane. More preferably, the moisture is eliminated from the comminuted polyurethane based on MCU foam until the water content is less than or equal to 0.03%. In another preferred embodiment, the moisture is eliminated from the comminuted polyurethane based on MCU foam by drying in an oven for at least 8 hours, but moisture may also be removed with an open heat source. After the moisture is substantially eliminated, the comminuted polyurethane based on MCU foam may be stored under vacuum. Alternatively, a desiccant may be added, or a combination of storage under vacuum and the addition of a desiccant may be employed. After substantially all of the moisture is removed, the comminuted polyurethane based on the MCU foam is suitable for use in the presently claimed invention.

In another preferred embodiment, the commercially available MCU foams that can be used to as the polyurethane polymer, or as the comminuted polyurethane polymer, of the presently claimed invention include Cellasto® Series MCU foam products commercially available from BASF Corporation of Florham Park, New Jersey. Alternatively, MCU foams can be obtained from commercial products incorporating MCU foams, such as footwear, automotive headliners, automotive front panels, and the like.

In another preferred embodiment, the polyurethane, and preferably a comminuted polyurethane, is a thermoplastic polyurethane (TPU).

In another preferred embodiment the term polyurea are polyurea objects or materials that have previously been formed (i.e., are pre-formed) as the reaction product of an isocyanate component (alternatively referred to herein as an isocyanate) and an isocyanate-reactive component. Preferably, the recycled polyurea polymer of the presently claimed invention are in the form of comminuted polyurea polymer. Comminuted polyurea polymer refer to polyurea polymer that are in powder form, or otherwise are in the form of minute particles or fragments. In general, polyurea compositions contain urea linkages formed by reacting an isocyanate group (—N═C═O) with an amine group (NH or —NH2). The chain length of the polyurea prepolymer is extended by reacting the prepolymer with an amine chain extender (curative). Hybrid compositions containing urethane and urea linkages also may be produced.

In another preferred embodiment, in the industrial applications, polyurethane-polyurea polymers are typically synthesized by the condensation reaction of a polyisocyanate, such as diphenylmethane diisocyanate, and a resin that includes a hydroxyl-containing material. Resins may also include linear polyesters, polyethers containing hydroxyl groups, amine-substituted aromatics, and aliphatic amines. The resulting polyurethane-polyurea polymer provides resistance to abrasion, weathering, and organic solvents and may be utilized in a variety of industrial applications as a sealant, caulking agent, or lining, for example.

### Component (B)

For the purposes of the present invention, the term “alkylene” covers acyclic saturated hydrocarbon residues, which may be acyclic saturated hydrocarbon chains, which combine different moieties, as in the case of C₁-C₃₀ alkylene with 1 to 30 (i.e. 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30) C atoms or with, as in the case of C₁-C₅ alkylene, 1 to 5 (i.e. 1, 2, 3, 4 or 5) C atoms. Representative examples of the alkylene groups include, but are not limited to, —CH₂—CH₂—, —CH₂—CH(CH₃)—, —CH₂—CH(CH₂CH₃)—, —CH₂—CH(n-C₃H₇)—, —CH₂—CH(n-C₄H₉)—, —CH₂—CH(n-C₅H₁₁)—, —CH₂—CH(n-C₆H₁₃)—, —CH₂—CH(n-C₇H₁₅)—, —CH₂—CH(n-C₈H₁₇)—, —CH(CH₃)—CH(CH₃)—, —C(CH₃)₂—, —CH₂—C(CH₃)₂—CH₂—, and —CH₂—[C(CH₃)₂]₂—CH₂—, —(CH₂)₃—, —(CH₂)₄—, —(CH₂)₅—, —(CH₂)₆—, —(CH₂)₈—, —(CH₂)₁₀—, —(CH₂)₇—, —(CH₂)₉—, —(CH₂)₁₁—, —(CH₂)₁₂—, —(CH₂)₁₃—, —(CH₂)₁₄—, —(CH₂)₁₅—, —(CH₂)₁₆—, —(CH₂)₁₇—, —(CH₂)₁₈—, —(CH₂)₁₉—, —(CH₂)₂₀—, —(CH₂)₂₁—, —(CH₂)₂₂—, —(CH₂)₂₃—, —(CH₂)₂₄—, —(CH₂)₂₅—, —(CH₂)₂₆—, —(CH₂)₂₇—, —(CH₂)₂₈—, —(CH₂)₂₉— and —(CH₂)₃₀—.

For the purposes of the present invention, the term “heteroalkylene” refers to an alkylene chain as described above, in which one or more carbon atoms have been replaced with heteroatoms each independently selected from the group consisting of oxygen, sulfur and nitrogen (NH). The heteroalkylene groups can preferably have 1, 2 or 3 heteroatom (s), particularly preferably 1 heteroatom selected from the group consisting of oxygen, sulfur and nitrogen (NH) as chain link(s). The heteroalkylene groups can preferably be 2- to 30-membered, particularly preferably 2- to 12-membered, very particularly preferably 2- or 6-membered. More preferably, ‘O’ is the most preferred heteroatom in “heteroalkylene”. Representative examples of the heteroalkylene groups include, but are not limited to, (—CH₂—O—CH₂—)₁₋₅₀₀, (—CH₂—O—CH(CH₃)—)₁₋₅₀₀, —CH₂—O—CH(CH₃)—, —CH₂—O—CH(CH₂CH₃)—, —CH₂—O—CH(n-C₃H₇)—, —CH₂—O—CH(n-C₄H₉)—, —CH₂—OCH(n-C₅H₁₁)—, —CH₂—O—CH(n-C₆H₁₃)—, —CH₂—O—CH(n-C₇H₁₅)—, —CH₂—O—CH(n-C₈H₁₇)—, —CHO—(CH₃)—CHO—(CH₃)—, —CO—(CH₃)₂—, —CH₂—O—C(CH₃)₂—CH₂—, —CH₂—[O—C(CH₃)₂]₂—CH₂—, —(CH₂)₃O—CH₂, —(CH₂)₄O—CH₂, —(CH₂)₅O—CH₂, —(CH₂)₆O—CH₂, —(CH₂)₈—OCH₂—, —(CH₂)₁₀—O—CH₂, —(CH₂)₇O—CH₂, —(CH₂)₉—O—CH₂, —(CH₂)₁₁—O—CH₂, —(CH₂)₁₂—O—CH₂, —(CH₂)₁₃—O—CH₂, —(CH₂)₁₄—O—CH₂, —(CH₂)₁₅—O—CH₂, —(CH₂)₁₆—O—CH₂, —(CH₂)₁₇—O—CH₂, —(CH₂)₁₈—O—CH₂, —(CH₂)₁₉—O—CH₂, —(CH₂)₂₀—O—CH₂, —(CH₂)₂₁—OCH₂, —(CH₂)₂₂—OCH₂, —(CH₂)₂₃—O—CH₂, —(CH₂)₂₄—OCH₂, —(CH₂)₂₅—OCH₂, —(CH₂)₂₆—OCH₂, —(CH₂)₂₇—O—CH₂, —(CH₂)₂₈—O—CH₂, —(CH₂)₂₉—O—CH₂— and —(CH₂)₃₀—O—CH₂, —CH₂—S—CH₂—, —CH₂—NH—CH₂—, —CH₂—NH— and —CH₂—CH₂—NH—CH₂—CH₂—.

The term “alkenylene” includes within the meaning of the present invention, acyclic unsaturated hydrocarbon chains having at least one double bond, preferably 1, 2 or 3 double bonds, and may be branched or linear and unsubstituted or at least monosubstituted with as in the case of C₂-C₃₀ alkenylene 2 to 30 (i.e. 2, 3, 4, 5, 6, 7, 8, 9, 10, 11, 12, 13, 14, 15, 16, 17, 18, 19, 20, 21, 22, 23, 24, 25, 26, 27, 28, 29 or 30) C-atoms, more preferably C₂-C₂₀ alkenylene, most preferably C₂-C₁₀ alkenylene, and in particular C₂-C₆ alkenylene. The representative examples include —CH═CH— and —CH₂—CH═CH—.

The term “heteroalkenylene” refers to an alkenylene chain as described above, in which one or more carbon atoms have been replaced with heteroatoms each independently selected from the group consisting of oxygen, sulfur and nitrogen (NH). The heteroalkenylene groups can preferably have 1, 2 or 3 heteroatom (s), particularly preferably 1 heteroatom selected from the group consisting of oxygen, sulfur and nitrogen (NH) as chain link(s). The heteroalkenylene groups can preferably be 3- to 30-membered, particularly preferably 3- to 12-membered, very particularly preferably 3- or 6-membered. The examples for heteroalkenylene groups are —CH═CH—NH—, —CH═CH—O—, —CH═CH—CH₂—O— and —CH═CH—S—.

In another preferred embodiment, if one or more of the substituents denote an alkylene, alkenylene, heteroalkylene and heteroalkenylene group or comprises such a group, which is mono- or polysubstituted, this group is preferably substituted with 1, 2, 3, 4 or 5, particularly preferably with 1, 2 or 3, substituents mutually independently selected from the group consisting of phenyl, F, Cl, Br, I, —NO₂, —CN, —O-phenyl, —O—CH₂-phenyl, —SH, —S-phenyl, —S—CH₂-phenyl, —NH₂, —N(C₁₋₅-alkyl)₂, —NH-phenyl, —N(C₁₋₅-alkyl)(phenyl), —N(C₁₋₅-alkyl)(CH₂-phenyl), —N(C₁₋₅-alkyl)(CH₂—CH₂-phenyl), —C(═O)—H, —C(═O)—C₁₋₅-alkyl, —C(═O)-phenyl, —C(═S)—C₁₋₅-alkyl, —C(═S)-phenyl, —C(═O)—OH, —C(═O)—O—C₁₋₅-alkyl, —C(═O)—O-phenyl, —C(═O)—NH₂, —C(═O)—NH—C₁₋₅-alkyl, —C(═O)—N(C₁₋₅-alkyl)₂, —S(═O)—C₁₋₅-alkyl, —S(═O)-phenyl, —S(═O)₂—C₁₋₅-alkyl, —S(═O)₂-phenyl, —S(═O)₂—NH₂ and —SO₃H, wherein the above-stated —C₁₋₅ alkyl residues in each case are linear or branched and the above-stated phenyl residues are unsubstituted or substituted with 1, 2, 3, 4 or 5, preferably with 1, 2, 3 or 4, substituents mutually independently selected from the group consisting of F, Cl, Br, I, —CN, —NO₂, —SH, —NH₂, —C(═O)—OH, —C₁₋₅ alkyl, —(CH₂)—O—C₁₋₅-alkyl, —C₂₋₅alkenyl, —C₂₋₅alkynyl, —C≡C—Si(CH₃)₃, —C≡C—Si(C₂H₅)₃, —S—C₁₋₅-alkyl, —S-phenyl, —S—CH₂-phenyl, —O—C₁₋₅-alkyl, —O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂ and —S—CH₂F. Most preferably alkylene, alkenylene, heteroalkylene and heteroalkenylene groups are unsubstituted or substituted with 1, 2 or 3 substituents mutually independently selected from the group consisting of phenyl, F, Cl, Br, I, —NO₂, —CN, —O-phenyl, —SH, —S-phenyl, —NH₂, —N(CH₃)₂, —N(C₂H₅)₂ and —N(CH₃) (C₂H₅), wherein the phenyl residue are unsubstituted or substituted with 1, 2, 3, 4 or 5 substituents mutually independently selected from the group consisting of F, Cl, Br, I, —OH, —SH, —NO₂, —CN, —O—CH₃, —O—CF₃, and —O—C₂H₅.

In another preferred embodiment, the term “cycloalkylene” covers saturated cyclic hydrocarbon residues. Representative examples of the C₅-C₃₀ cycloalkylene groups include, but are not limited to, cyclopentylene (e.g., cyclopenta-1,3-ylene, cyclopenta-1,2-ylene), cyclohexylene (eg, cyclohexa-1,4-ylene, cyclohexa-1,3-ylene and cyclohexa-1,2-ylene), cycloheptylene, cyclooctylene groups (e.g. 1,5-cyclooctylene). The term “cycloalkylene” also covers a bridged cyclic hydrocarbon group such as a cyclic hydrocarbon group with 2 to 4 rings having 5 to 30 carbon atoms including, but not limited to, norbornylene groups (e.g. 1,4-norbornylene group and 2,5-norbornylene group), and admantylene groups (e.g. 1,5-admantylene group and 2,6-admantylene group).

In another preferred embodiment, the term “heterocycloalkylene”, for the purposes of this application, refers to a cyclic or polycyclic, saturated divalent radical having from 5 to 30 ring members in which carbon atoms are replaced with 1, 2 or 3 heteroatom(s) selected from the group consisting of N, O and S. This term is further exemplified by such groups as 1,5-dioxaoctylene, 4,8-dioxabicyclo[3.3.0]octylene and the like.

In another preferred embodiment, the term “cycloalkenylene” covers a bivalent cycloalkenyl ring structure, i.e., the cycloalkenyl group as defined herein having two single bonds as points of attachment to other groups. For example, the “cycloalkenylene” includes, but is not limited to, cyclopent-1,2-en-3,5-ylene, 3-cyclohexene-1,2-ylene, 2,5-cyclohexadiene-1,4-ylene, cyclohex-1,2-en-3,5-ylene, 2,5-cyclohexadiene-1,4-ylene and cyclohept-1,2-en-3,5-ylene.

In another preferred embodiment, the term “heterocycloalkenylene”, for the purposes of this application, refers to a cyclic or polycyclic, nonaromatic unsaturated divalent radical having from 5 to 30 carbon atoms in which carbon atoms are replaced with 1, 2 or 3 heteroatom(s) selected from N, O and S heteroatom and having 1, 2 or 3 double bond(s).

In another preferred embodiment, if one or more of the substituents denote a cycloalkylene, cycloalkenylene, heterocycloalkylene, and heterocycloalkenylene which is mono- or polysubstituted, this group is preferably substituted with 1, 2, 3, 4 or 5, particularly preferably with 1, 2 or 3, substituents mutually independently selected from the group consisting of phenyl, F, Cl, Br, I, —NO₂, —CN, —O-phenyl, —O—CH₂-phenyl, —SH, —S— phenyl, —S—CH₂-phenyl, —NH₂, —N(C₁₋₅-alkyl)₂, —NH-phenyl, —N(C₁₋₅-alkyl)(phenyl), —N(C₁₋₅-alkyl)(CH₂-phenyl), —N(C₁₋₅-alkyl)(CH₂—CH₂-phenyl), —C(═O)—H, —C(═O)C₁₋₅-alkyl, —C(═O)-phenyl, —C(═S)—C₁₋₅-alkyl, —C(═S)-phenyl, —C(═O)—OH, —C(═O)—O—C₁₋₅-alkyl, —C(═O)—O-phenyl, —C(═O)—NH₂, —C(═O)—NH—C₁₋₅-alkyl, —C(═O)—N(C₁₋₅-alkyl)₂, —S(═O)—C₁₋₅-alkyl, —S(═O)-phenyl, —S(═O)₂—C₁₋₅-alkyl, —S(═O)₂-phenyl, —S(═O)₂—NH₂ and —SO₃H, wherein the above-stated-C₁₋₅ alkyl residues in each case are linear or branched and the above-stated phenyl residues are unsubstituted or substituted with 1, 2, 3, 4 or 5, preferably with 1, 2, 3 or 4, substituents mutually independently selected from the group consisting of F, Cl, Br, I, —CN, —NO₂, —SH, —NH₂, —C(═O)—OH, —C₁₋₅alkyl, —(CH₂)—O—C₁₋₅-alkyl, —C₂₋₅alkenyl, —C₂₋₅alkynyl, —C≡C—Si(CH₃)₃, —C≡C—Si(C₂H₅)₃, —S—C₁₋₅-alkyl, —S-phenyl, —S—CH₂-phenyl, —O—C₁₋₅-alkyl, —O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂ and —S—CH₂F. Most preferably alkylene, alkenylene, heteroalkylene and heteroalkenylene groups are unsubstituted or substituted with 1, 2 or 3 substituents mutually independently selected from the group consisting of phenyl, F, Cl, Br, I, —NO₂, —CN, —O-phenyl, —SH, —S-phenyl, —NH₂, —N(CH₃)₂, —N(C₂H₅)₂ and —N(CH₃)(C₂H₅), wherein the phenyl residue is unsubstituted or substituted with 1, 2, 3, 4 or 5 substituents mutually independently selected from the group consisting of F, Cl, Br, I, —SH, —NO₂, —CN, —O—CH₃, —O—CF₃, and —O—C₂H₅.

In another preferred embodiment, the term “arylene”, refers to a closed aromatic divalent ring or ring system such as phenylene, naphthylene, biphenylene, fluorenylene, and indenyl.

In another preferred embodiment, the term “heteroarylene”, refers to a closed aromatic divalent ring or ring system having at least one heteroatom selected from nitrogen, oxygen and sulfur. Suitable heteroarylene groups include furylene, thienylene, pyridylene, quinolinylene, isoquinolinylene, indolylene, isoindolylene, triazolylene, pyrrolylene, tetrazolylene, imidazolylene, pyrazolylene, oxazolylene, thiazolylene, benzofuranylene, benzothiophenylene, carbazolylene, benzoxazolylene, pyrimidinylene, benzimidazolylene, quinoxalinylene, benzothiazolylene, naphthyridinylene, isoxazolylene, isothiazolylene, purinylene, quinazolinylene, pyrazinylene, 1-oxidopyridylene, pyridazinylene, triazinylene, tetrazinylene, oxadiazolylene and thiadiazolylene.

In another preferred embodiment, if one or more of the substituents denote an arylene and a heteroarylene which is mono- or polysubstituted, this is preferably substituted with 1, 2, 3 or 4, particularly preferably with 1, 2 or 3, substituents mutually independently selected from the group consisting of phenyl, F, Cl, Br, I, —NO₂, —CN, —O— phenyl, —O—CH₂-phenyl, —SH, —S-phenyl, —S—CH₂-phenyl, —NH₂, —N(C₁₋₅-alkyl)₂, —NH-phenyl, —N(C₁₋₅-alkyl)(phenyl), —N(C₁₋₅-alkyl)(CH₂-phenyl), —N(C₁₋₅-alkyl)(CH₂—CH₂-phenyl), —C(═O)—H, —C(═O)—C₁₋₅-alkyl, —C(═O)-phenyl, —C(═S)—C₁₋₅-alkyl, —C(═S)-phenyl, —C(═O)—OH, —C(═O)—O—C₁₋₅-alkyl, —C(═O)—O-phenyl, —C(═O)—NH₂, —C(═O)—NH—C₁₋₅-alkyl, —C(═O)—N(C₁₋₅-alkyl)₂, —S(═O)—C₁₋₅-alkyl, —S(═O)-phenyl, —S(═O)₂—C₁₋₅-alkyl, —S(═O)₂-phenyl, —S(═O)₂—NH₂ and —SO₃H, wherein the above-stated-C₁₋₅ alkyl residues in each case are linear or branched and the above-stated phenyl residues are unsubstituted or substituted with 1, 2, 3, 4 or 5, preferably with 1, 2, 3 or 4, substituents mutually independently selected from the group consisting of F, Cl, Br, I, —CN, —NO₂, —SH, —NH₂, —C(═O)—OH, —C₁₋₅ alkyl, —(CH₂)—O—C₁₋₅-alkyl, —C₂₋₅ alkenyl, —C₂₋₅ alkynyl, —C≡C—Si(CH₃)₃, —C≡C—Si(C₂H₅)₃, —S—C₁₋₅-alkyl, —S-phenyl, —S—CH₂-phenyl, —O—C₁₋₅-alkyl, —O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂ and —S—CH₂F. Most preferably alkylene, alkenylene, heteroalkylene and heteroalkenylene groups are unsubstituted or substituted with 1, 2 or 3 substituents mutually independently selected from the group consisting of phenyl, F, Cl, Br, I, —NO₂, —CN, —O-phenyl, —SH, —S-phenyl, —NH₂, —N(CH₃)₂, —N(C₂H₅)₂ and —N(CH₃)(C₂H₅), wherein the phenyl residue is unsubstituted or substituted with 1, 2, 3, 4 or 5 substituents mutually independently selected from the group consisting of F, Cl, Br, I, —SH, —NO₂, —CN, —O—CH₃, —O—CF₃, and —O—C₂H₅.

For the purposes of the present invention, the term “alkyl” covers acyclic saturated hydrocarbon residues, which may be branched or linear and unsubstituted or at least monosubstituted with, as in the case of C₁-C₃₀ alkyl, 1 to 30 (i.e. 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30) C atoms or with, as in the case of C₁-C₅ alkyl, 1 to 5 (i.e. 1, 2, 3, 4 or 5) C atoms. If one or more of the substituents denote an alkyl residue or comprise an alkyl residue which is mono- or polysubstituted, this is preferably substituted with 1, 2, 3, 4 or 5, particularly preferably with 1, 2 or 3, substituents mutually independently selected from the group consisting of F, Cl, Br, I, —NO₂, —CN, —SH, —NH₂, —N(C₁₋₅-alkyl)₂, —N(C₁₋₅-alkyl)(phenyl), —N(C₁₋₅-alkyl)(CH₂-phenyl), —N(C₁₋₅-alkyl)(CH₂—CH₂-phenyl), —C(═O)—H, —C(═O)—C₁₋₅-alkyl, —C(═O)phenyl, —C(═S)—C₁₋₅-alkyl, —C(═S)-phenyl, —C(═O)—OH, —C(═O)—O—C₁₋₅-alkyl, —C(═O)—)phenyl, —C(═O)—NH₂, —C(═O)—NH—C₁₋₅-alkyl, —C(═O)—N(C₁₋₅-alkyl)₂, —S(═O)—C₁₋₅-alkyl, —S(═O)-phenyl, —S(═O)₂—C₁₋₅-alkyl, —S(═O)₂-phenyl, —S(═O)₂—NH₂ and —SO₃H, wherein the above-stated C₁₋₅-alkyl residues are in each case linear or branched and the above-stated phenyl residues are unsubstituted or substituted with 1, 2, 3, 4 or 5 substituents mutually independently selected from the group consisting of F, Cl, Br, I, —CN, —CF₃, —NH₂, —O—CF₃, —SH, —O—CH₃, —O—C₂H₅, —O—C₃H₇, methyl, ethyl, n-propyl, isopropyl, n-butyl, 2-butyl, isobutyl and tert-butyl. Particularly preferred substituents may be selected mutually independently from the group consisting of F, Cl, Br, I, —NO₂, —CN, —SH, —NH₂, —N(CH₃)₂, —N(C₂H₅)₂ and —N(CH₃)(C₂H₅).

In a preferred embodiment, the unsubstituted linear C₁-C₃₀ alkyl is preferably selected from the group consisting of methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, henicosyl, docosyl, tricosyl and tetracosyl; more preferably selected from the group consisting of hexyl, heptyl, octyl, nonyl, decyl, undecyl, dodecyl, tridecyl, tetradecyl, pentadecyl, hexadecyl, heptadecyl, octadecyl, nonadecyl, eicosyl, henicosyl, docosyl, tricosyl and tetracosyl; even more preferably selected from the group consisting of methyl, ethyl, propyl, butyl, pentyl, hexyl, heptyl, octyl, nonyl, decyl, undecyl, dodecyl, tridecyl, tetradecyl and pentadecyl; most preferably selected from the group consisting of methyl, ethyl, propyl, butyl, pentyl, hexyl, heptyl, octyl, nonyl, decyl, undecyl and dodecyl; and in particular preferably selected from the group consisting of methyl, ethyl, propyl, butyl, pentyl, hexyl, heptyl, octyl, nonyl and decyl.

In a preferred embodiment, the unsubstituted branched C₁-C₃₀ alkyl is preferably selected from the group consisting of isopropyl, iso-butyl, neo-pentyl, 2-ethyl-hexyl, 2-propyl-heptyl, 2-butyl-octyl, 2-pentyl-nonyl, 2-hexyl-decyl, iso-hexyl, iso-heptyl, iso-octyl, iso-nonyl, iso-decyl, iso-dodecyl, iso-tetradecyl, iso-hexadecyl, iso-octadecyl and iso-eicosyl, more preferably selected from the group consisting of 2-ethyl-hexyl, 2-propylheptyl, 2-butyl-octyl, 2-pentyl-nonyl, 2-hexyl-decyl, iso-hexyl, iso-heptyl, iso-octyl, isononyl, iso-decyl, iso-dodecyl, iso-tetradecyl, iso-hexadecyl, iso-octadecyl, iso-eicosyl, 2-methyltricosyl, 2-ethyldocosyl, 3-ethylhenicosyl, 3-ethylicosyl, 4-propylhenicosyl, propylnonadecyl, 6-butyldodecyl and 5-ethylundecyl. The polysubstituted alkyl residues are understood to be those alkyl residues which are either poly-, preferably di- or trisubstituted, either on different or on the same C atoms, for example trisubstituted on the same C atom as in the case of —CF₃, or at different locations as in the case of —(CHCl)—(CH₂F). Polysubstitution may proceed with identical or different substituents. Examples which may be mentioned of suitable substituted alkyl residues are —CF₃, —CF₂H, —CFH₂, —(CH₂)—OH, —(CH₂)—NH₂, —(CH₂)—CN, —(CH₂)—(CF₃), —(CH₂)—(CHF₂), —(CH₂)—(CH₂F), —(CH₂)—(CH₂)—O—CH₃, —(CH₂)—(CH₂)—NH₂, —(CH₂)—(CH₂)—CN, —(CF₂)—(CF₃), —(CH₂)—(CH₂)—(CF₃), and —(CH₂)—(CH₂)—(CH₂)—O—CH₃.

In another preferred embodiment, the substituted, linear or branched, C₁-C₃₀ alkyl refers to a branched or linear saturated hydrocarbon group having C₁-C₃₀ carbon atoms substituted with functional groups selected from the group consisting of F, Cl, Br, I, —NO₂, —CN, —SH, —NH₂, —N(C₁₋₅-alkyl)₂, —N(C₁₋₅-alkyl)(phenyl), —N(C₁₋₅-alkyl)(CH₂-phenyl), —N(C₁₋₅-alkyl)(CH₂—CH₂-phenyl), —C(═O)—H, —C(═O)—C₁₋₅-alkyl, —C(═O)-phenyl, —C(═S)—C₁₋₅-alkyl, —C(═S)-phenyl, —C(═O)—OH, —C(═O)—O—C₁₋₅-alkyl, —C(═O)—)-phenyl, —C(═O)—NH₂, —C(═O)—NH—C₁₋₅-alkyl, —C(═O)—N(C₁₋₅-alkyl)₂, —S(═O)—C₁₋₅-alkyl, —S(═O)-phenyl, —S(═O)₂—C₁₋₅-alkyl, —S(═O)₂-phenyl, —S(═O)₂—NH₂ and —SO₃H, wherein the above-stated C₁₋₅-alkyl residues are in each case linear or branched and the above-stated phenyl residues are preferably unsubstituted or substituted with 1, 2, 3, 4 or 5 substituents mutually independently selected from the group consisting of F, Cl, Br, I, —CN, —CF₃, —NH₂, —O—CF₃, —SH, —O—CH₃, —O—C₂H₅, —O—C₃H₇, methyl, ethyl, n-propyl, isopropyl, n-butyl, 2-butyl, isobutyl and tert-butyl. Particularly preferred substituents may be selected mutually independently from the group consisting of F, Cl, Br, I, —NO₂, —CN, —SH, —NH₂, —N(CH₃)₂, —N(C₂H₅)₂ and —N(CH₃)(C₂H₅).

In another preferred embodiment, the substituted, linear or branched, C₁-C₃₀ alkyl refers to a branched or linear saturated hydrocarbon group having C₁-C₃₀ carbon atoms substituted with functional groups selected from the group consisting of alkoxy, C(═O)R, CN and SR, preferably selected from the group consisting of 1-methoxy methyl, 1-methoxy methyl, 1-methoxy ethyl, 1-methoxy propyl, 1-methoxy butyl, 1-methoxy pentyl, 1-methoxy hexyl, 1-methoxy heptyl, 1-methoxy octyl, 1-methoxy nonyl, decyl, 1-methoxy undecyl, 1-methoxy dodecyl, 1-methoxy tridecyl, 1-methoxy tetradecyl, 1-methoxy pentadecyl, 1-methoxy hexadecyl, 1-methoxy heptadecyl, 1-methoxy octadecyl, 1-methoxy nonadecyl, 1-methoxy eicosyl, 1-methoxy henicosyl, 1-methoxy docosyl, 1-methoxy tricosyl, 1-methoxy tetracosyl, 2-methoxy propyl, 2-methoxy butyl, 2-methoxy pentyl, 2-methoxy hexyl, 2-methoxy heptyl, 2-methoxy octyl, 2-methoxy nonyl, decyl, 2-methoxy undecyl, 2-methoxy dodecyl, 2-methoxy tridecyl, 2-methoxy tetradecyl, 2-methoxy pentadecyl, 2-methoxy hexadecyl, 2-methoxy heptadecyl, 2-methoxy octadecyl, 2-methoxy nonadecyl, 2-methoxy eicosyl, 2-methoxy henicosyl, 2-methoxy docosyl, 2-methoxy tricosyl, 2-methoxy tetracosyl, 1-acetoxy methyl, 1-acetoxy ethyl, 1-acetoxy propyl, 1-acetoxy butyl, 1-acetoxy pentyl, 1-acetoxy hexyl, 1-acetoxy heptyl, 1-acetoxy octyl, 1-acetoxy nonyl, decyl, 1-acetoxy undecyl, 1-acetoxy dodecyl, 1-acetoxy tridecyl, 1-acetoxy tetradecyl, 1-acetoxy pentadecyl, 1-acetoxy hexadecyl, 1-acetoxy heptadecyl, 1-acetoxy octadecyl, 1-acetoxy nonadecyl, 1-acetoxy eicosyl, 1-acetoxy henicosyl, 1-acetoxy docosyl, 1-acetoxy tricosyl, 1-acetoxy tetracosyl, 1-cyano methyl, 1-cyano ethyl, 1-cyano propyl, 1-cyano butyl, 1-cyano pentyl, 1-cyano hexyl, 1-cyano heptyl, 1-cyano octyl, 1-cyano nonyl, decyl, 1-cyano undecyl, 1-cyano dodecyl, 1-cyano tridecyl, 1-cyano tetradecyl, 1-cyano pentadecyl, 1-cyano hexadecyl, 1-cyano heptadecyl, 1-cyano octadecyl, 1-cyano nonadecyl, 1-cyano eicosyl, 1-cyano henicosyl, 1-cyano docosyl, 1-cyano tricosyl, 1-cyano tetracosyl, 2-cyano propyl, 2-cyano butyl, 2-cyano pentyl, 2-cyano hexyl, 2-cyano heptyl, 2-cyano octyl, 2-cyano nonyl, decyl, 2-cyano undecyl, 2-cyano dodecyl, 2-cyano tridecyl, 2-cyano tetradecyl, 2-cyano pentadecyl, 2-cyano hexadecyl, 2-cyano heptadecyl, 2-cyano octadecyl, 2-cyano nonadecyl, 2-cyano eicosyl, 2-cyano henicosyl, 2-cyano docosyl, 2-cyano tricosyl, 2-cyano tetracosyl, 1-thioyl methyl, 1-thioyl ethyl, 1-thioyl propyl, 1-thioyl butyl, 1-thioyl pentyl, 1-thioyl hexyl, 1-thioyl heptyl, 1-thioyl octyl, 1-thioyl nonyl, decyl, 1-thioyl undecyl, 1-thioyl dodecyl, 1-thioyl tridecyl, 1-thioyl tetradecyl, 1-thioyl pentadecyl, 1-thioyl hexadecyl, 1-thioyl heptadecyl, 1-thioyl octadecyl, 1-thioyl nonadecyl, 1-thioyl eicosyl, 1-thioyl henicosyl, 1-thioyl docosyl, 1-thioyl tricosyl and 1-thioyl tetracosyl.

In a preferred embodiment, the term alkenyl denotes unsubstituted, linear C₂-C₃₀ alkenyl which is preferably selected from the group consisting of 1-propenyl, 1-butenyl, 1-pentenyl, 1-hexenyl, 2-hexenyl, 1-heptenyl, 2-heptenyl, 1-octenyl, 2-octenyl, 1-nonenyl, 2-nonenyl, 1-decenyl, 2-decenyl, 1-undecenyl, 2-undecenyl, 1-dodecenyl, 2-dodecenyl, 1-tridecenyl, 2-tridecenyl, 1-tetradecenyl, 2-tetradecenyl, 1-pentadecenyl, 2-pentadecenyl, 1-hexadecenyl, 2-hexadecenyl, 1-heptadecenyl, 2-heptadecenyl, 1-octadecenyl, 2-octadecenyl, 1-nonadecenyl, 2-nonadecenyl, 1-eicosenyl and 2-eicosenyl, more preferably selected from 1-hexenyl, 2-hexenyl, 1-heptenyl, 2-heptenyl, 1-octenyl, 2-octenyl, 1-nonenyl, 2-nonenyl, 1-decenyl, 2-decenyl, 1-undecenyl, 2-undecenyl, 1-dodecenyl, 2-dodecenyl, 1-tridecenyl, 2-tridecenyl, 1-tetradecenyl, 2-tetradecenyl, 1-pentadecenyl, 2-pentadecenyl, 1-hexadecenyl, 2-hexadecenyl, 1-heptadecenyl, 2-heptadecenyl, 1-octadecenyl, 2-octadecenyl, 1-nonadecenyl, 2-nonadecenyl, 1-eicosenyl and 2-eicosenyl, 20-henicosenyl, 2-docosenyl, 6-tricosenyl and 2-tetracosenyl.

In a preferred embodiment, the unsubstituted branched C₂-C₃₀ alkenyl is selected from the group consisting of isopropenyl, iso-butenyl, neo-pentenyl, 2-ethyl-hexenyl, 2-propyl-heptenyl, 2-butyl-octenyl, 2-pentyl-nonenyl, 2-hexyl-decenyl, iso-hexenyl, iso-heptenyl, iso-octenyl, iso-nonenyl, iso-decenyl, iso-dodecenyl, iso-tetradecenyl, iso-hexadecenyl, iso-octadecenyl, iso-eicosenyl, 2-methyl tricosenyl, 2-ethyl docosenyl, 3-ethylhenicosenyl, 3-ethyl icosenyl, 4-propylhenicosenyl, 4-propylnonadecenyl, 6-butyldodecenyl, 5-ethylundedcenyl, 1,4-hexadienyl, 1,3-hexadienyl, 2,5-hexadienyl, 3,5-hexadienyl, 2,4-hexadienyl, 1,3,5-hexatrienyl, 1,3,6-heptatrienyl, 1,4,7-octatrienyl or 2-methyl-1,3,5hexatrienyl, 1,3,5,7-octatetraenyl, 1,3,5,8-nonatetraenyl, 1,4,7,10-undecatetraenyl, 2-ethyl-1,3,6,8-nonatetraenyl, 2-ethenyl-1,3,5,8-nonatetraenyl, 1,3,5,7,9-decapentaenyl, 1,4,6,8,10-undecapentaenyl, and 1,4,6,9,11-dodecapentaenyl.

In a preferred embodiment, the substituted, linear or branched, C₂-C₃₀ alkenyl refers to a branched or an linear unsaturated hydrocarbon group having C₂-C₃₀ carbon atoms substituted with functional groups selected from alkoxy, C(═O)R, CN and SR; wherein R is hydrogen, substituted or unsubstituted, linear or branched C₁-C₃₀ alkyl, substituted or unsubstituted, linear or branched C₂-C₃₀ alkenyl, substituted or unsubstituted C₅-C₃₀ cycloalkyl, substituted or unsubstituted C₅-C₃₀ cycloalkenyl, substituted or unsubstituted C₆-C₃₀ aryl, substituted or unsubstituted C₇-C₃₀ arylalkyl.

In a preferred embodiment, the term alkenyl refers to a branched or an linear unsaturated hydrocarbon group having C₂-C₃₀ carbon atoms substituted with functional groups selected from, alkoxy, C(═O)R, CN and SR; preferably selected from the group consisting of 1-methoxy ethenyl, 2-methoxy propenyl, 4-methoxy butenyl, 3-methoxy pentenyl, 5-methoxy hexenyl, 2-methoxy heptenyl, 5-methoxy octenyl, 3-methoxy nonenyl, 6-methoxy undecenyl, 1-methoxy dodec-2-enyl, 1-methoxy tridec-5-enyl, 3-methoxy tetradic-5-enyl, 3-methoxy pentade-12-encyl, 10-methoxy hexadec-15-enyl, 12-methoxy heptadic-16-enyl, 1-methoxy octadec-3-enyl, 1-methoxy nonadec-2-enyl, 1-methoxy eicos-20-enyl, 1-methoxy henicos-2-enyl, 1-methoxy docos-4-enyl, 1-methoxy tricos-22-enyl, 1-methoxy tetracos-23-enyl, 2-methoxy prop-1-enyl, 2-methoxy but-1-enyl, 2-methoxy pent-4-enyl, 2-methoxy hex-2-enyl, 2-methoxy hept-3-enyl, 2-methoxy oct-7-enyl, 2-methoxy non-5-enyl, 2-methoxy undec-10-enyl, 2-methoxy dodec-4-enyl, 2-methoxy tridec-12-enyl, 2-methoxy tetradic-10-enyl, 2-methoxy pentadec-14-enyl, 2-methoxy hexadec-1-enyl, 2-methoxy heptadic-1-enyl, 2-methoxy octadic-12-enyl, 2-methoxy nonadec-10-enyl, 2-methoxy eicos-18-enyl, 2-methoxy henicos-2-enyl, 2-methoxy docos-3-enyl, 20-methoxy tricos-2-enyl, 21-methoxy tetracos-4-enyl, 1-acetoxy ethenyl, 1-acetoxy prop-1-enyl, 1-acetoxy but-2-enyl, 1-acetoxy pent-4-enyl, 1-acetoxy hex-2-enyl, 1-acetoxy hept-1-enyl, 1-acetoxy oct-7-enyl, 1-acetoxy non-2-enyl, 5-acetoxy dec-3-enyl, 1-acetoxy undec-10-enyl, 1-acetoxy dodec-2-enyl, 1-acetoxy tridec-12-enyl, 10-acetoxy tetradec-2-enyl, 15-acetoxy pentadec-2-enyl, 10-acetoxy hexadec-2-enyl, 11-acetoxy heptadec-1-enyl, 13-acetoxy octadec-2-enyl, 1-acetoxy nonadec-14-enyl, 20-acetoxy eicos-19-enyl, 1-acetoxy henicos-2-enyl, 1-acetoxy docos-10-enyl, 1-acetoxy tricos-22-enyl, 1-acetoxy tetracos-23-enyl, 1-cyano eth-1-enyl, 1-cyano prop-2-enyl, 1-cyano but-2-enyl, 1-cyano pent-3-enyl, 1-cyano hex-5-enyl, 1-cyano hept-6-enyl, 1-cyano oct-2-enyl, 1-cyano non-3-enyl, 11-cyano undec-2-enyl, 10-cyano dodec-2-enyl, 10-cyano tridec-12-enyl, 1-cyano tetradec-3-enyl, 1-cyano pentadec-14-enyl, 1-cyano hexadec-15-enyl, 1-cyano heptadec-2-enyl, 1-cyano octadec-3-enyl, 1-cyano nonadec-18-enyl, 1-cyano eicos-10-enyl, 1-cyano henicos-20-enyl, 15-cyano docos-3-enyl, 1-cyano tricos-20-enyl, 1-cyano tetracos-2-enyl, 2-cyano prop-2-enyl, 2-cyano but-1-enyl, 2-cyano pent-1-enyl, 2-cyano hex-3-enyl, 2-cyano hept-6-enyl, 2-cyano oct-1-enyl, 2-cyano non-8-enyl, 2-cyano undec-10-enyl, 2-cyano dodec-1-enyl, 2-cyano tridec-12-enyl, 2-cyano tetradec-10-enyl, 2-cyano pentadec-3-enyl, 2-cyano hexadec-2-enyl, 2-cyano heptadec-1-enyl, 2-cyano octadec-12-enyl, 2-cyano nonadec-15-enyl, 2-cyano eicos-1-enyl, 2-cyano henicos-5-enyl, 2-cyano docos-20-enyl, 2-cyano tricos-22-enyl, 2-cyano tetracos-20-enyl, 1-thionyl eth-1-enyl, 1-thionyl prop-2-enyl, 1-thionyl but-2-enyl, 1-thionyl pent-4-enyl, 1-thionyl hex-2-enyl, 1-thionyl hept-5-enyl, 1-thionyl oct-3-enyl, 1-thionyl non-5-enyl, 1-thionyl undec-10-enyl, 1-thionyl dodec-11-enyl, 1-thionyl tridec-2-enyl, 1-thionyl tetradec-4-enyl, 1-thionyl pentadec-5-enyl, 1-thionyl hexadec-3-enyl, 1-thionyl heptadec-2-enyl, 1-thionyl octadec-3-enyl, 1-thionyl nonadec-15-enyl, 1-thionyl eicos-18-enyl, 1-thionyl henicos-20-enyl, 1-thionyl docos-21-enyl, 1-thionyl tricos-20-enyl and 1-thionyl tetracos-22-enyl.

In a preferred embodiment, the term “heteroalkyl” refers to an alkyl group, in which one or more carbon atoms have in each case been replaced by a heteroatom mutually independently selected from the group consisting of oxygen, sulfur and nitrogen (NH). Heteroalkyl residues preferably comprise 1, 2 or 3 heteroatom(s) mutually independently selected from the group consisting of oxygen, sulfur and nitrogen (NH) as chain link(s). Heteroalkyl residues may preferably be 2- to 12-membered, particularly preferably 2- to 6-membered.

In a preferred embodiment, the term “heteroalkenyl” refers to an alkenyl group, in which one or more carbon atoms have in each case been replaced by a heteroatom mutually independently selected from the group consisting of oxygen, sulfur and nitrogen (NH). Heteroalkenyl residues preferably comprise 1, 2 or 3 heteroatom(s) mutually independently selected from the group consisting of oxygen, sulfur and nitrogen (NH) as chain link(s). Heteroalkenyl residues may preferably be 3- to 12-membered, particularly preferably 3- to 6-membered.

In a preferred embodiment, the term “cycloalkyl” refers to a monocyclic and bicyclic saturated cycloaliphatic radical having 5 to 30 carbon atoms. Representative examples of unsubstituted or branched C₅-C₃₀ monocyclic and bicyclic cycloalkyl include, but are not limited to, cyclopentyl, cyclohexyl, cycloheptyl, cyclooctyl, bicyclo[2.2.1]heptyl, and bicyclo[3.1.1]heptyl.

In another preferred embodiment, the C₅-C₃₀ monocyclic and bicyclic cycloalkyl can be further branched with one or more equal or different alkyl groups such as methyl, ethyl, n-propyl, iso-propyl, n-butyl, iso-butyl, n-pentyl, iso-pentyl, neo-pentyl etc. The representative examples of branched C₃-C₁₀ monocyclic and bicyclic cycloalkyl include, but are not limited to, methyl cyclohexyl and dimethyl cyclohexyl.

In a preferred embodiment, the term “cycloalkenyl” refers to a monocyclic and bicyclic unsaturated cycloaliphatic radical having 5 to 30 carbon atoms, which comprises one or more double bonds. Representative examples of C₅-C₃₀ cycloalkenyl include, but are not limited to, cyclopentenyl, cyclohexenyl, cycloheptenyl, cyclooctenyl, cyclononenyl or cyclodecenyl. These radicals can be branched with one or more equal or different alkyl radical, preferably with methyl, ethyl, n-propyl or iso-propyl. The representative examples of branched C₅-C₃₀ monocyclic and bicyclic cycloalkenyl include, but are not limited to, methyl cyclohexenyl and dimethyl cyclohexenyl.

In a preferred embodiment, the term “heterocycloalkyl” means a non-aromatic monocyclic or polycyclic ring comprising 5 to 30 ring members in which at least one carbon atom as a ring member is replaced with at least one heteroatom selected from 0, S, and N. Examples of heterocycloalkyl groups include aziridinyl, pyrrolidinyl, pyrrolidino, piperidinyl, piperidino, piperazinyl, piperazino, morpholinyl, morpholino, thiomorpholinyl, thiomorpholino, tetrahydrofuranyl, tetrahydrothiofuranyl, tetrahydropyranyl and pyranyl.

In a preferred embodiment, the term “heterocycloalkenyl” means a non-aromatic unsaturated monocyclic or polycyclic ring comprising 5 to 30 ring members in which at least carbon atom as ring member is replaced with at least one heteroatom selected from O, S, and N and having at least one double bond. The example include, but are not limited to, (2,3)-dihydrofuranyl, (2,3)-dihydrothienyl, (2,3)-dihydropyrrolyl, (2,5)-dihydropyrrolyl, (2,5)-dihydropyrrolyl, (2,3)-dihydroisoxazolyl, (1,4)-dihydropyridin-1-yl, di-hydropyranyl, 2,3-dihydropyrazol-1-yl, 2,3-dihydropyrazol-2-yl, 2,3-dihydropyrazol-3-yl, 2,3-dihydropyrazol-4-yl, 2,3-dihydropyrazol-5-yl, 3,4-dihydropyrazol-1-yl, 3,4-dihydropyrazol-3-yl, 3,4-dihydropyrazol-4-yl, 3,4-dihydropyrazol-5-yl, 4,5-dihydropyrazol-1-yl, 4,5-dihydropyrazol-3-yl, 4,5-dihydropyrazol-4-yl, 4,5-dihydropyrazol-5-yl, 2,3-dihydrooxazol-2-yl, 2,3-dihydrooxazol-3-yl, 2,3-dihydrooxazol-4-yl, 2,3-dihydrooxazol-5-yl, 3,4-dihydrooxazol-2-yl, 3,4-dihydrooxazol-3-yl, 3,4-dihydrooxazol-4-yl, 4,5-dihydropyrazol-2-yl, 4,5-dihydropyrazol-3-yl, 4,5-dihydropyrazol-4-yl, 4,5-dihydropyrazol-5-yl, 2,5-dihydrothienyl and (1,2,3,4)-tetrahydropyridin-1-yl.

In another preferred embodiment, if one or more of the substituents denote a heteroalkyl, heteroalkenyl, cycloalkyl, cycloalkenyl, heterocycloalkyl and heterocycloalkenyl which is mono- or polysubstituted, this group is preferably substituted with 1, 2, 3, 4 or 5, particularly preferably with 1, 2 or 3, substituents mutually independently selected from the group consisting of F, Cl, Br, I, —CN, —NO₂, —OH, —SH, —NH₂, oxo (═O), thioxo (═S), —C(═O)—OH, C₁₋₅ alkyl, —C₂₋₅ alkenyl, —C₂₋₅ alkynyl, —C≡C—Si(CH₃)₃, —C≡C—Si(C₂H₅)₃, —(CH₂)—O—C₁₋₅-alkyl, —S—C₁₋₅-alkyl, —S-phenyl, —S—CH₂-phenyl, —O—C₁₋₅-alkyl, —O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂, —S—CH₂F, —S(═O)₂-phenyl, —S(═O)₂—C₁₋₅-alkyl, —S(═O)—C₁₋₅-alkyl, —NH—C₁₋₅-alkyl, N(C₁₋₅alkyl)(C₁₋₅-alkyl), —C(═O)—O—C₁₋₅-alkyl, —C(═O)—H, —C(═O)—C₁₋₅-alkyl, —CH₂—O—C(═O)-phenyl, —O—C(═O)-phenyl, —NH—S(═O)₂—C₁₋₅-alkyl, —NH—C(═O)—C₁₋₅-alkyl, —C(═O)NH₂, —C(═O)—NH—C₁₋₅-alkyl, —C(═O)—N(C₁₋₅-alkyl)₂, pyrazolyl, phenyl, furyl (furanyl), thiadiazolyl, thiophenyl (thienyl) and benzyl, wherein the above-stated C₁₋₅ alkyl residues are in each case linear or branched and the cyclic substituents or the cyclic residues of these substituents themselves are in each case unsubstituted or substituted with 1, 2, 3, 4 or 5, preferably with 1, 2, 3 or 4, substituents mutually independently selected from the group consisting of F, Cl, Br, I, —CN, —CF₃, —OH, —NH₂, —O—CF₃, —SH, —O—C₁₋₅-alkyl, —O-phenyl, —O—CH₂-phenyl, —(CH₂)—O—C₁₋₅-alkyl, —S—C₁₋₅-alkyl, —S-phenyl, —S—CH₂-phenyl, —C₁₋₅ alkyl, —C₂₋₅ alkenyl, —C₂₋₅ alkynyl, —C≡C—Si(CH₃)₃, —C≡C—Si(C₂H₅)₃, —C(═O)—O—C₁₋₅-alkyl and —C(═O)—CF₃.

In a preferred embodiment, the term “aryl” refers to an aromatic compound that may have more than one aromatic ring. The representative examples for substituted and unsubstituted C₆-C₃₀ aryl include phenyl, naphthyl, anthracenyl, tetraphenyl, phenalenyl and phenanthrenyl.

In a preferred embodiment, the term “heteroaryl” means a monocyclic or polycyclic, preferably a mono-, bi- or tricyclic aromatic hydrocarbon residue with preferably 5, 6, 7, 8, 9, 10, 11, 12, 13, 14, 15, 16, 17, 18, 19, 20, 21, 22, 23, 24, 25, 26, 27, 28, 29 or 30 ring members, particularly preferably with 5, 6, 9, 10, 13 or 14 ring atoms, very particularly preferably with 5 or 6 ring members, in which one or more carbon atoms as ring members have been replaced with heteroatoms each independently selected from the group consisting of oxygen, sulfur and nitrogen (NH). Heteroaryl residues may preferably comprise 1, 2, 3, 4 or 5, particularly preferably 1, 2 or 3, heteroatom(s) mutually independently selected from the group consisting of oxygen, sulfur and nitrogen (NH) as ring member(s) A heteroaryl residue is unsubstituted or monosubstituted or identically or differently polysubstituted. The examples of suitable heteroaryl residues which may be mentioned are thienyl, furyl, pyrrolyl, pyrazolyl, pyrazinyl, pyranyl, triazolyl, pyridinyl, imidazolyl, indolyl, isoindolyl, benzo[b]furanyl, benzo[b]thiophenyl, benzo[d]thiazolyl, benzodiazolyl, benzotriazolyl, benzoxazolyl, benzisoxazolyl, thiazolyl, thiadiazolyl, oxazolyl, oxadiazolyl, isoxazolyl, pyridazinyl, pyrimidinyl, indazolyl, quinoxalinyl, quinazolinyl, quinolinyl, naphthridinyl and isoquinolinyl.

For the purposes of the present invention aryl or heteroaryl residues may be fused (anellated) with a mono- or bicyclic ring system. Examples which may be mentioned of aryl residues which are fused with a mono- or bicyclic ring system are (1,2,3,4)-tetrahydroquinolinyl, (1,2,3,4)-tetrahydroisoquinolinyl, (2,3)-dihydro-1H-isoindolyl, (1,2,3,4)-tetrahydronaphthyl, (2,3)-dihydrobenzo[1.4]dioxinyl, benzo[1.3]dioxolyl and (3,4)-dihydro-2H-benzo[1.4]oxazinyl.

In another preferred embodiment, the “arylalkyl” refers to an aryl ring attached to an alkyl chain. The representative examples for the arylalkyl include, but are not limited to, 1-phenylmethyl, 1-phenylethyl, 1-phenylpropyl, 1-phenylbutyl, 1-methyl-1-phenyl-propyl, 3-phenylpropyl, 4-phenylbutyl, 3-phenylbutyl and 2-methyl-3-phenyl-propyl.

In another preferred embodiment, if one or more of the substituents denote an aryl, heteroaryl or arylalkyl residue or comprise an aryl or heteroaryl residue which is mono- or polysubstituted, this may preferably be substituted with 1, 2, 3, 4 or 5, particularly preferably with 1, 2 or 3, substituents mutually independently selected from the group consisting of F, Cl, Br, I, —CN, —NO₂, —SH, —NH₂, —C(═O)—OH, —C₁₋₅ alkyl, —(CH₂)—O—C₁₋₅-alkyl, —C₂₋₅ alkenyl, —C₂₋₅ alkynyl, —C≡C—Si(CH₃)₃, —C≡C—Si(C₂H₅)₃, —S—C₁₋₅-alkyl, —S-phenyl, —S—CH₂-phenyl, —O—C₁₋₅-alkyl, —O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂, —S—CH₂F, —S(═O)₂-phenyl, —S(═O)₂—C₁₋₅-alkyl, —S(═O)—C₁₋₅-alkyl, —NH—C₁₋₅-alkyl, N(C₁₋₅alkyl)₂, —C(═O)—O—C₁₋₅-alkyl, —C(═O)—H; —C(═O)—C₁₋₅-alkyl, —CH₂—O—C(═O)-phenyl, —O—C(═O)-phenyl, —NH—S(═O)₂—C₁₋₅-alkyl, —NH—C(═O)—C₁₋₅-alkyl, —C(═O)—NH₂, —C(═O)—NH—C₁₋₅-alkyl, —C(═O)—N(C₁₋₅-alkyl)₂, pyrazolyl, phenyl, furyl (furanyl), thiazolyl, thiadiazolyl, thiophenyl (thienyl), benzyl and phenethyl, wherein the above-stated C₁₋₅ alkyl residues are in each case linear or branched and the cyclic substituents or the cyclic residues of these substituents themselves are unsubstituted or substituted with 1, 2, 3, 4 or 5, preferably with 1, 2, 3 or 4, substituents mutually independently selected from the group consisting of F, Cl, Br, I, —CN, —NO₂, —SH, —NH₂, —C(═O)—OH, —C₁₋₅ alkyl, —(CH₂)—O—C₁₋₅-alkyl, —C₂₋₅ alkenyl, —C₂₋₅ alkynyl, —C≡C—Si(CH₃)₃, —C≡C—Si(C₂H₅)₃, —S—C₁₋₅-alkyl, —S— phenyl, —S—CH₂-phenyl, —O—C₁₋₅-alkyl, —O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂ and —S—CH₂F; most preferably, the substituents are in each case mutually independently selected from the group consisting of F, Cl, Br, I, —CN, —NO₂, methyl, ethyl, n-propyl, isopropyl, n-butyl, isobutyl, 2-butyl, tert.-butyl, n-pentyl, neopentyl, ethenyl, allyl, ethynyl, propynyl, —C≡C—Si(CH₃)₃, —C≡C—Si(C₂H₅)₃, —CH₂—O—CH₃, —CH₂—O—C₂H₅, —SH, —NH₂, —C(═O)—OH, —S—CH₃, —S—C₂H₅, —S(═O)—CH₃, —S(═O)₂—CH₃, —S(═O)—C₂H₅, —S(═O)₂—C₂H₅, —O—CH₃, —O—C₂H₅, —O—C₃H₇, —O—C(CH₃)₃, —CF₃, —CHF₂, —CH₂F, —O—CF₃, —O—CHF₂, —O—CH₂F, —C(═O)—CF₃, —S—CF₃, —S—CHF₂, —S—CH₂F, —S(═O)₂-phenyl, pyrazolyl, phenyl, —N(CH₃)₂, —N(C₂H₅)₂, —NH—CH₃, —NH—C₂H₅, —CH₂—O—C(═O)-phenyl, —NH—S(═O)₂—CH₃, —C(═O)—O—CH₃, —C(═O)—O—C₂H₅, —C(═O)—O—C(CH₃)₃, —C(═O)—H, —C(═O)—CH₃, —C(═O)C₂H₅, —NH—C(═O)—CH₃, —NH—C(═O)—C₂H₅, —O—C(═O)-phenyl, —C(═O)—NH₂, —C(═O)—NH—CH₃, —C(═O)—N(CH₃)₂, phenyl, furyl (furanyl), thiadiazolyl, thiophenyl (thienyl) and benzyl, wherein the cyclic substituents or the cyclic residues of these substituents themselves are in each case unsubstituted or substituted with 1, 2, 3, 4, or 5, preferably with 1, 2, 3 or 4, substituents mutually independently selected from the group consisting of F, Cl, Br, I, —CN, —NO₂, —SH, —NH₂, —C(═O)—OH, methyl, ethyl, n-propyl, isopropyl, n-butyl, isobutyl, 2-butyl, tert.-butyl, n-pentyl, neopentyl, ethenyl, allyl, ethynyl, propynyl, —C≡C—Si(CH₃)₃, —C≡C—Si(C₂H₅)₃, —CH₂—O—CH₃, —CH₂—O—C₂H₅, —S—CH₃, —S—C₂H₅, —S(═O)—CH₃, —S(═O)₂—CH₃, —S(═O)—C₂H₅, —S(═O)₂—C₂H₅, —O—CH₃, —O—C₂H₅, —O—C₃H₇, —O—C(CH₃)₃, —CF₃, —CHF₂, —CH₂F, —O—CF₃, —O—CHF₂, —O—CH₂F, —C(═O)—CF₃, —S—CF₃, —S—CHF₂ and —S—CH₂F.

In another preferred embodiment, a substituted aryl residue may be selected from the group consisting of 2-methylphenyl, 3-methylphenyl, 4-methylphenyl, 2-fluorophenyl, 3-fluorophenyl, 4-fluorophenyl, 2-cyanophenyl, 3-cyanophenyl, 4-cyanophenyl, 2-aminophenyl, 3-aminophenyl, 4-aminophenyl, 2-dimethylaminophenyl, 3-dimethylaminophenyl, 4-dimethylaminophenyl, 2-methylaminophenyl, 3-methylaminophenyl, 4-methylaminophenyl, 2-acetylphenyl, 3-acetylphenyl, 4-acetylphenyl, 2-methylsulfinylphenyl, 3-methylsulfinylphenyl, 4-methylsulfinylphenyl, 2-methylsulfonylphenyl, 3-methylsulfonylphenyl, 4-methylsulfonylphenyl, 2-methoxyphenyl, 3-methoxyphenyl, 4-methoxyphenyl, 2-chlorophenyl, 3-chlorophenyl, 4-chlorophenyl, 2-ethoxyphenyl, 3-ethoxyphenyl, 4-ethoxyphenyl, 2-trifluoromethylphenyl, 3-trifluoromethylphenyl, 4-trifluoromethylphenyl, 2-difluoromethylphenyl, 3-difluoromethylphenyl, 4-difluoromethylphenyl, 2-fluoromethylphenyl, 3-fluoromethylphenyl, 4-fluoromethylphenyl, 2-nitrophenyl, 3-nitrophenyl, 4-nitrophenyl, 2-ethylphenyl, 3-ethylphenyl, 4-ethylphenyl, 2-propylphenyl, 3-propylphenyl, 4-propylphenyl, 2-isopropylphenyl, 3-isopropylphenyl, 4-isopropylphenyl, 2-tert.-butylphenyl, 3-tert.-butylphenyl, 4-tert.-butylphenyl, 2-carboxyphenyl, 3-carboxyphenyl, 4-carboxyphenyl, 2-ethenylphenyl, 3-ethenylphenyl, 4-ethenylphenyl, 2-ethynylphenyl, 3-ethynylphenyl, 4-ethynylphenyl, 2-allylphenyl, 3-allylphenyl, 4-allylphenyl, 2-trimethylsilanylethynylphenyl, 3-trimethylsilanylethynylphenyl, 4-trimethylsilanylethynylphenyl, 2-formylphenyl, 3-formylphenyl, 4-formylphenyl, 2-acetaminophenyl, 3-acetaminophenyl, 4-acetaminophenyl, 2-dimethylaminocarbonylphenyl, 3-dimethylaminocarbonylphenyl, 4-dimethylaminocarbonylphenyl, 2-methoxymethylphenyl, 3-methoxymethylphenyl, 4-methoxymethylphenyl, 2-ethoxymethylphenyl, 3-ethoxymethylphenyl, 4-ethoxymethylphenyl, 2-aminocarbonylphenyl, 3-aminocarbonylphenyl, 4-aminocarbonylphenyl, 2-methylaminocarbonylphenyl, 3-methylaminocarbonylphenyl, 4-methylaminocarbonylphenyl, 2-carboxymethyl ester phenyl, 3-carboxymethyl ester phenyl, 4-carboxymethyl ester phenyl, 2-carboxyethyl ester phenyl, 3-carboxyethyl ester phenyl, 4-carboxyethyl ester phenyl, 2-carboxy-tert.-butyl ester phenyl, 3-carboxy-tert.-butyl ester phenyl, 4-carboxy-tert.-butyl ester phenyl, 2-methylmercaptophenyl, 3-methylmercaptophenyl, 4-methylmercaptophenyl, 2-ethylmercaptophenyl, 3-ethylmercaptophenyl, 4-ethylmercaptophenyl, 2-biphenyl, 3-biphenyl, 4-biphenyl, 2-bromophenyl, 3-bromophenyl, 4-bromophenyl, 2-iodophenyl, 3-iodophenyl, 4-iodophenyl, 2-trifluoromethoxyphenyl, 3-trifluoromethoxyphenyl, 4-trifluoro-methoxyphenyl, 2-fluoro-3-trifluoromethylphenyl, 2-fluoro-4-methylphenyl, (2,3)-difluorophenyl, (2,3)-dimethylphenyl, (2,3)-dichlorophenyl, 3-fluoro-2-trifluoro-methylphenyl, (2,4)-dichlorophenyl, (2,4)-difluorophenyl, 4-fluoro-2-trifluoromethylphenyl, (2,4)-dimethoxyphenyl, 2-chloro-4-fluorophenyl, 2-chloro-4-nitrophenyl, 2-chloro-4-methylphenyl, 2-chloro-5-trifluoromethylphenyl, 2-chloro-5-methoxyphenyl, 2-bromo-5-trifluoromethylphenyl, 2-bromo-5-methoxyphenyl, (2,4)-dibromophenyl, (2,4)-dimethylphenyl, 2-fluoro-4-trifluoromethylphenyl, (2,5)-difluorophenyl, 2-fluoro-5-trifluoro-methylphenyl, 5-fluoro-2-trifluoromethylphenyl, 5-chloro-2-trifluoromethylphenyl, 5-bromo-2-trifluoromethylphenyl, (2,5)-dimethoxyphenyl, (2,5)-bis-trifluoromethylphenyl, (2,5)-dichlorophenyl, (2,5)-dibromophenyl, 2-methoxy-5-nitrophenyl, 2-fluoro-6-trifluoro-methylphenyl, (2,6)-dimethoxyphenyl, (2,6)-dimethylphenyl, (2,6)-dichlorophenyl, 2-chloro-6-fluorophenyl, 2-bromo-6-chlorophenyl, 2-bromo-6-fluorophenyl, (2,6)-difluorophenyl, (2,6)-difluoro-3-methylphenyl, (2,6)-dibromophenyl, (2,6)-dichlorophenyl, 3-chloro-2-fluorophenyl, 3-chloro-5-methylphenyl, (3,4)-dichlorophenyl, (3,4)-dimethylphenyl, 3-methyl-4-methoxyphenyl, 4-chloro-3-nitrophenyl, (3,4)-dimethoxyphenyl, 4-fluoro-3-trifluoromethylphenyl, 3-fluoro-4-trifluoromethylphenyl, (3,4)-difluorophenyl, 3-cyano-4-fluorophenyl, 3-cyano-4-methylphenyl, 3-cyano-4-methoxyphenyl, 3-bromo-4-fluorophenyl, 3-bromo-4-methylphenyl, 3-bromo-4-methoxyphenyl, 4-chloro-2-fluorophenyl, 4-chloro-3-trifluoromethyl, 4-bromo-3-methylphenyl, 4-bromo-5-methylphenyl, 3-chloro-4-fluorophenyl, 4-fluoro-3-nitrophenyl, 4-bromo-3-nitrophenyl, (3,4)-dibromophenyl, 4-chloro-3-methylphenyl, 4-bromo-3-methylphenyl, 4-fluoro-3-methylphenyl, 3-fluoro-4-methylphenyl, 3-fluoro-5-methylphenyl, 2-fluoro-3-methylphenyl, 4-methyl-3-nitrophenyl, (3,5)-dimethoxyphenyl, (3,5)-dimethylphenyl, (3,5)-bis-trifluoromethylphenyl, (3,5)-difluorophenyl, (3,5)-dinitrophenyl, (3,5)-dichlorophenyl, 3-fluoro-5-trifluoromethylphenyl, 5-fluoro-3-trifluoro-methylphenyl, (3,5)-dibromophenyl, 5-chloro-4-fluorophenyl, 5-chloro-4-fluorophenyl, 5-bromo-4-methylphenyl, (2,3,4)-trifluorophenyl, (2,3,4)-trichlorophenyl, (2,3,6)-trifluorophenyl, 5-chloro-2-methoxyphenyl, (2,3)difluoro-4-methyl, (2,4,5)-trifluorophenyl, (2,4,5)-trichlorophenyl, (2,4)-dichloro-5-fluorophenyl, (2,4,6)-trichlorophenyl, (2,4,6)-trimethylphenyl, (2,4,6)-trifluorophenyl, (2,4,6)trimethoxyphenyl, (3,4,5)-trimethoxyphenyl, (2,3,4,5)-tetrafluorophenyl, 4-methoxy(2,3,6)-trimethylphenyl, 4-methoxy-(2,3,6)-trimethylphenyl, 4-chloro-2,5-dimethylphenyl, 2-chloro-6-fluoro-3-methylphenyl, 6-chloro-2-fluoro-3-methyl, (2,4,6)-trimethylphenyl and (2,3,4,5,6)-pentafluorophenyl.

In another preferred embodiment, a substituted heteroaryl residue may be selected from the group consisting of 3-methylpyrid-2-yl, 4-methylpyrid-2-yl, 5-methylpyrid-2-yl, 6-methylpyrid-2-yl, 2-methylpyrid-3-yl, 4-methylpyrid-3-yl, 5-methylpyrid-3-yl, 6-methylpyrid-3-yl, 2-methylpyrid-4-yl, 3-methylpyrid-4-yl, 3-fluoropyrid-2-yl, 4-fluoropyrid-2-yl, 5-fluoropyrid-2-yl, 6-fluoropyrid-2-yl, 3-chloropyrid-2-yl, 4-chloropyrid-2-yl, 5-chloropyrid-2-yl, 6-chloropyrid-2-yl, 3-trifluoromethylpyrid-2-yl, 4-trifluoromethylpyrid-2-yl, 5-trifluoromethylpyrid-2-yl, 6-trifluoromethylpyrid-2-yl, 3-methoxypyrid-2-yl, 4-methoxypyrid-2-yl, 5-methoxypyrid-2-yl, 6-methoxypyrid-2-yl, 4-methylthiazol-2-yl, 5-methylthiazol-2-yl, 4-trifluoromethylthiazol-2-yl, 5-trifluoromethylthiazol-2-yl, 4-chlorothiazol-2-yl, 5-chlorothiazol-2-yl, 4-bromothiazol-2-yl, 5-bromothiazol-2-yl, 4-fluorothiazol-2-yl, 5-fluorothiazol-2-yl, 4-cyanothiazol-2-yl, 5-cyanothiazol-2-yl, 4-methoxythiazol-2-yl, 5-methoxythiazol-2-yl, 4-methyloxazol-2-yl, 5-methyloxazol-2-yl, 4-trifluoromethyloxazol-2-yl, 5-trifluoromethyloxazol-2-yl, 4-chlorooxazol-2-yl, 5-chlorooxazol-2-yl, 4-bromooxazol-2-yl, 5-bromooxazol-2-yl, 4-fluorooxazol-2-yl, 5-fluorooxazol-2-yl, 4-cyanooxazol-2-yl, 5-cyanooxazol-2-yl, 4-methoxyoxazol-2-yl, 5-methoxyoxazol-2-yl, 2-methyl-(1,2,4)-thiadiazol-5-yl, 2-trifluoromethyl-(1,2,4)-thiadiazolyl-5-yl, 2-chloro(1,2,4)-thiadiazol-5-yl, 2-fluoro-(1,2,4)-thiadiazol-5-yl, 2-methoxy-(1,2,4)-thiadiazol-5-yl, 2-cyano-(1,2,4)-thiadiazol-5-yl, 2-methyl-(1,2,4)-oxadiazol-5-yl, 2-trifluoromethyl(1,2,4)-oxadiazol-5-yl, 2-chloro-(1,2,4)-oxadiazol-5-yl, 2-fluoro-(1,2,4)-oxadiazol-5-yl, 2-methoxy-(1,2,4)-oxadiazol-5-yl and 2-cyano-(1,2,4)-oxadiazol-5-yl.

In another preferred embodiment, Rₐ is selected from the group consisting of substituted or unsubstituted, linear or branched C₁-C₃₀ alkylene, substituted or unsubstituted C₅-C₃₀ cycloalkylene, substituted or unsubstituted C₁-C₃₀ alkylene C₅-C₃₀ cycloalkylene and substituted or unsubstituted C₆-C₃₀ arylene C₁-C₃₀ alkylene C₆-C₃₀ arylene; more preferably Rₐ is selected from the group consisting of substituted or unsubstituted, linear or branched C₁-C₂₀ alkylene, substituted or unsubstituted C₅-C₂₀ cycloalkylene, substituted or unsubstituted C₁-C₂₀ alkylene C₅-C₂₀ cycloalkylene and substituted or unsubstituted C₆-C₂₀ arylene C₁-C₂₀ alkylene C₆-C₂₀ arylene; even more preferably Rₐ is selected from the group consisting of substituted or unsubstituted, linear or branched C₁-C₁₀ alkylene, substituted or unsubstituted C₅-C₁₀ cycloalkylene, substituted or unsubstituted C₁-C₁₀ alkylene C₅-C₁₀ cycloalkylene and substituted or unsubstituted C₆-C₁₀ arylene C₁-C₁₀ alkylene C₆-C₁₀ arylene; most preferably Rₐ is selected from the group consisting of substituted or unsubstituted, linear or branched C₁-C₁₀ alkylene, substituted or unsubstituted C₅-C₈ cycloalkylene, substituted or unsubstituted C₁-C₈ alkylene C₅-C₈ cycloalkylene and substituted or unsubstituted C₆-C₈ arylene C₁-C₈ alkylene C₆-C₈ arylene; and in particular Rₐ is selected from the group consisting of substituted or unsubstituted, linear or branched C₁-C₁₀ alkylene, substituted or unsubstituted C₅-C₇ cycloalkylene, substituted or unsubstituted C₁-C₈ alkylene C₅-C₇ cycloalkylene and substituted or unsubstituted C₆-C₇ arylene C₁-C₈ alkylene C₆-C₇ arylene.

In another preferred embodiment, R_{b}, R_{c}, R_{d}, Rₑ, R_{f} and R_{g} independently of each other are selected from the group consisting of linear or branched, substituted or unsubstituted C₁-C₃₀ alkyl, substituted or unsubstituted C₅-C₃₀ cycloalkyl, substituted or unsubstituted C₆-C₃₀ aryl and substituted or unsubstituted 5- to 30-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, or unsaturated, unsubstituted or substituted 5- to 30-membered carbocyclic ring that contains 0, 1, 2 or 3 heteroatom(s) selected from O, N or S as ring member(s); more preferably R_{b}, R_{c}, R_{d}, Rₑ, R_{f} and R_{g} independently of each other are selected from the group consisting of linear or branched, substituted or unsubstituted C₁-C₂₀ alkyl, substituted or unsubstituted C₅-C₂₀ cycloalkyl, substituted or unsubstituted C₆-C₂₀ aryl and substituted or unsubstituted 5- to 20-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, or unsaturated, unsubstituted or substituted 5- to 20-membered carbocyclic ring that contains 0, 1, 2 or 3 heteroatom(s) selected from O, N or S as ring member(s); even more preferably R_{b}, R_{c}, R_{d}, Rₑ, R_{f} and R_{g} independently of each other are selected from the group consisting of linear or branched, substituted or unsubstituted C₁-C₁₀ alkyl, substituted or unsubstituted C₅-C₁₀ cycloalkyl, substituted or unsubstituted C₆-C₁₀ aryl and substituted or unsubstituted 5- to 10-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, or unsaturated, unsubstituted or substituted 5- to 10-membered carbocyclic ring that contains 0, 1, 2 or 3 heteroatom(s) selected from O, N or S as ring member(s); most preferably R_{b}, R_{c}, R_{d}, Rₑ, R_{f} and R_{g} independently of each other are selected from the group consisting of linear or branched, substituted or unsubstituted C₁-C₁₀ alkyl, substituted or unsubstituted C₅-C₇ cycloalkyl, substituted or unsubstituted C₆-C₇ aryl, and substituted or unsubstituted 5- to 7-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, or unsaturated, unsubstituted or substituted 5- to 10-membered carbocyclic ring that contains 0, 1, 2 or 3 heteroatom(s) selected from O, N or S as ring member(s); and in particular R_{b}, R_{c}, R_{d}, Rₑ, R_{f} and R_{g} independently of each other are selected from the group consisting of linear or branched, substituted or unsubstituted C₁-C₁₀ alkyl, substituted or unsubstituted C₅-C₇ cycloalkyl, substituted or unsubstituted C₆-C₇ aryl, and substituted or unsubstituted 5- to 7-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, or unsaturated, unsubstituted or substituted 5- to 10-membered carbocyclic ring that contains 0, 1 or 2 heteroatom(s) selected from 0 or N as ring member(s).

In another preferred embodiment, R_{b}, R_{c}, R_{d}, Rₑ, R_{f} and R_{g} independently of each other are selected from the group consisting of hydrogen, linear or branched, substituted or unsubstituted C₁-C₃₀ alkyl, substituted or unsubstituted C₅-C₃₀ cycloalkyl and substituted or unsubstituted C₆-C₃₀ aryl;
R_{b} and Rₑ together with the carbon atoms to which they are bonded, or
R_{c} and R_{d} together with the carbon atoms to which they are bonded, or
R_{f} and Rₑ together with the carbon atoms to which they are bonded form a saturated, unsaturated or aromatic, unsubstituted or substituted 5- to 30-membered carbocyclic ring that contains 0, 1, 2 or 3 heteroatom(s) selected from O, N or S as ring member(s).

In another preferred embodiment, Rₐ is selected from the group consisting of substituted or unsubstituted, linear or branched C₁-C₁₀ alkylene, substituted or unsubstituted, linear or branched C₂-C₃₀ alkenylene, substituted or unsubstituted C₅-C₁₀ cycloalkylene, substituted or unsubstituted C₅-C₈ cycloalkenylene, substituted or unsubstituted C₆-C₁₀ arylene, substituted or unsubstituted C₁-C₁₀ alkylene C₅-C₈ cycloalkylene, substituted or unsubstituted C₁-C₁₀ alkylene 5- to 10-membered heterocycloalkylene, substituted or unsubstituted C₁-C₁₀ alkylene C₆-C₁₀ arylene, C₅-C₁₀ cycloalkylene and substituted or unsubstituted C₂-C₁₀ alkenylene 5- to 10-membered heterocycloalkylene.

In another preferred embodiment, the secondary amine of formula (B) is selected from the group consisting of N1,N3-diisopropyl-4-methyl-cyclohexane-1,3-diamine, 4-methyl-N1,N3-disec-butyl-cyclohexane-1,3-diamine, 2-methyl-N1,N3-disec-butyl-cyclohexane-1,3-diamine, N1,N3-dibenzyl-2-methyl-cyclohexane-1,3-diamine, N1,N3-dibenzyl-4-methyl-cyclohexane-1,3-diamine, N1,N3-bis(2-ethylhexyl)-4-methyl-cyclohexane-1,3-diamine, N-isopropyl-3-[(isopropylamino)methyl]-3,5,5-trimethyl-cyclohexanamine, N-sec-butyl-4-[[4-(sec-butylamino)phenyl]methyl]aniline, N,N′-bis(2,2,6,6-tetramethyl-4-piperidyl)hexane-1,6-diamine, N,N′-diethyl-2-butene-1,4-diamine, N,N′-diisopropyl-1,3-propanediamine, N,N′-diisopropylethylenediamine, N,N′-dimethyl-1,3-propanediamine, 1,4,8,11-tetraazacyclotetradecane-5,7-dione, 1,4-diazacycloheptane, 1,2-dimethylethylenediamine, 1,2-diisopropylethylenediamine, N-(pyrrolidin-2-ylmethyl)cyclohexanamine, N-(pyrrolidin-2-ylmethyl)cycloheptanamine and 2-methyl-N-(pyrrolidin-2-ylmethyl)propan-2-amine.

In another preferred embodiment, the at least one polyisocyanate (C) is selected from the group consisting of isophorone diisocyanate, propylene-1,2-diisocyanate, propylene-1,3-diisocyanate, butylene-1,2-diisocyanate, butylene-1,3-diisocyanate, hexamethylene-1,6-diisocyanate, 2-methylpentamethylene-1,5-diisocyanate, 2-ethylbutylene-1,4-diisocyanate, 1,5-pentamethylene diisocyanate, methyl-2,6-diisocyanate caproate, octamethylene-1,8-diisocyanate, 2,4,4-trimethylhexamethylene-1,6-diisocyanate, nonamethylene diisocyanate, 2,2,4-trimethylhexamethylene-1,6-diisocyanate, decamethylene-1,10-diisocyanate, 2,11-diisocyanato-dodecane, meta-phenylene diisocyanate, paraphenylene diisocyanate, toluene-2,4-diisocyanate, toluene-2,6-diisocyanate, xylene-2,4-diisocyanate, xylene-2,6-diisocyanate, methylpropylbenzene diisocyanate, methylethylbenzene diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene-bis(4-phenyl isocyanate), ethylene-bis(4-phenyl isocyanate), isopropylidenebis(4-phenyl isocyanate), butylene-bis(4-phenylisocyanate), 2,2′-oxydiphenyl diisocyanate, 3,3′-oxydiphenyl diisocyanate, 4,4′-oxydiphenyl diisocyanate, 2,2′-ketodiphenyl diisocyanate, 3,3′-ketodiphenyl diisocyanate, 4,4′-ketodiphenyl diisocyanate, 2,2′-mercaptodiphenyl diisocyanate, 3,3′-mercaptodiphenyl diisocyanate, 4,4′-thiodiphenyl diisocyanate, 2,2′-diphenylsulfone diisocyanate, 3,3′-diphenylsulfone diisocyanate, 4,4′-diphenylsulfone diisocyanate, 2,2,-methylene-bis(cyclohexyl isocyanate), 3,3′-methylenebis(cyclohexyl isocyanate), 4,4′-methylene-bis(cyclohexyl isocyanate), 4,4′-ethylenebis(cyclohexyl isocyanate), 4,4′-propylene-bis-(cyclohexyl isocyanate), bis(para-isocyano-cyclohexyl)sulfide, bis(para-isocyanato-cyclohexyl)sulfone, bis(para-isocyano-cyclohexyl)ether, bis(para-isocyanato-cyclohexyl)diethyl silane, bis(para-isocyanato-cyclohexyl)diphenyl silane, bis(para-isocyanato-cyclohexyl)ethyl phosphine oxide, bis(para-isocyanato-cyclohexyl)phenyl phosphine oxide, bis(para-isocyanato-cyclohexyl)N-phenyl amine, bis(para-isocyanato-cyclohexyl)N-methyl amine, 3,3′-dimethyl-4,4′-diisocyano biphenyl, 3,3′-dimethoxy-biphenylene diisocyanate, 2, 4-bis(b-isocyanato-t-butyl)toluene, bis(para-b-isocyanato-t-butyl-phenyl)ether, para-bis(2-methyl-4-isocyanatophenyl)benzene, 3,3-diisocyanato adamantane, 3,3-diisocyano biadamantane, 3,3-diiso-cyanatoethyl-1′-biadamantane, 1,2-bis (3-isocyanato-propoxy)ethane, 2,2-dimethyl propylene diisocyanate, 3-methoxy hexamethylene-1,6-diisocyanate, 2,5-dimethyl heptamethylene diisocyanate, 5-methyl nonamethylene-1,9-diisocyanate, 1,4-diisocyanato cyclohexane, 1,2-diisocyanato octadecane, 2,5-diisocyanato-1,3,4-oxadiazole, OCN(CH₂)₃O(CH₂)₂O(CH₂)₃NCO, OCN(CH₂)₃N(CH₃)(CH₂)₃NCO, triphenylmethane-4,4′,4″-triisocyanate, toluene-2,4,6-triyl triisocyanate, ethyl ester 1-lysine triisocyanate, 1,6,11-triisocyanatoundecane, 2,2-bis[[4-(isocyanatomethyl)phenyl]methyl]butyl n-[[4-(isocyanatomethyl)phenyl]methyl]carbamate, (2,4,6-trioxotriazine-1,3,5(2h,4h,6h)triyl)tris(hexamethylene) isocyanate, 1,3,5-triisocyanatobenzene, tris(isocyanatohexyl)biuret, 3,3′,3″-[(1h,3h,5h)-2,4,6-trioxo-1,3,5-triazine-1,3,5-triyltris(methylene)]tris[3,5,5-trimethylcyclohexyl] triisocyanate, 1,3,5-triazine-2,4,6-triisocyanate, 2,4,4′-triisocyanato-dicyclohexylmethane, triisocyanate triphenylthiophosphate, 2,4,4′-diphenylether triisocyanate and polymeric form of diisocyanates and triisocyanates; more preferably the at least one polyisocyanate (C) is selected from the group consisting of isophorone diisocyanate, hexamethylene-1,6-diisocyanate, 2-methylpentamethylene-1,5-diisocyanate, 2-ethylbutylene-1,4-diisocyanate, 1,5-pentamethylene diisocyanate, methyl-2,6-diisocyanate caproate, octamethylene-1,8-diisocyanate, 2,4,4-trimethylhexamethylene-1,6-diisocyanate, 2,2,4-trimethylhexamethylene-1,6-diisocyanate, meta-phenylene diisocyanate, para-phenylene diisocyanate, toluene-2,4-diisocyanate, toluene-2,6-diisocyanate, xylene-2,4-diisocyanate, xylene-2,6-diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene-bis(4-phenyl isocyanate), 2,2′-oxydiphenyl diisocyanate, 3,3′-oxydiphenyl diisocyanate, 4,4′-oxydiphenyl diisocyanate, 2,2′-diphenylsulfone diisocyanate, 3,3′-diphenylsulfone diisocyanate, 4,4′-diphenylsulfone diisocyanate, 2,2,-methylene-bis(cyclohexyl isocyanate), 3,3′-methylenebis(cyclohexyl isocyanate), 4,4′-methylene-bis(cyclohexyl isocyanate), 4,4′-ethylenebis(cyclohexyl isocyanate), 4,4′-propylene-bis-(cyclohexyl isocyanate), bis(para-isocyano-cyclohexyl)sulfide, bis(para-isocyanato-cyclohexyl)sulfone, bis(para-isocyano-cyclohexyl)ether, 3,3′-dimethyl-4,4′-diisocyano biphenyl, 3,3′-dimethoxy-biphenylene diisocyanate, 2, 4-bis(b-isocyanato-t-butyl)toluene, bis(para-b-isocyanato-t-butyl-phenyl)ether, para-bis(2-methyl-4-isocyanatophenyl)benzene, 3,3-diisocyanato adamantane, 3,3-diisocyano biadamantane, 3,3-diiso-cyanatoethyl-1′-biadamantane, 1,2-bis (3-isocyanato-propoxy)ethane, 1,4-diisocyanato cyclohexane, OCN(CH₂)₃O(CH₂)₂O(CH₂)₃NCO, OCN(CH₂)₃N(CH₃)(CH₂)₃NCO, triphenylmethane-4,4′,4″-triisocyanate, toluene-2,4,6-triyl triisocyanate, ethyl ester 1-lysine triisocyanate, 1,6,11-triisocyanatoundecane, 2,2-bis[[4-(isocyanatomethyl)phenyl]methyl]butyl n-[[4-(isocyanatomethyl)phenyl]methyl]carbamate, (2,4,6-trioxotriazine-1,3,5(2h,4h,6h)triyl)tris(hexamethylene) isocyanate, 1,3,5-triisocyanatobenzene, tris(isocyanatohexyl)biuret, 3,3′,3″-[(1h,3h,5h)-2,4,6-trioxo-1,3,5-triazine-1,3,5-triyltris(methylene)]tris[3,5,5-trimethylcyclohexyl] triisocyanate, 1,3,5-triazine-2,4,6-triisocyanate, 2,4,4′-triisocyanato-dicyclohexylmethane, triisocyanate triphenylthiophosphate, 2,4,4′-diphenylether triisocyanate and polymeric form of diisocyanates and triisocyanates; even more preferably the at least one polyisocyanate (C) is selected from the group consisting of isophorone diisocyanate, hexamethylene-1,6-diisocyanate, 1,5-pentamethylene diisocyanate, octamethylene-1,8-diisocyanate, meta-phenylene diisocyanate, para-phenylene diisocyanate, toluene-2,4-diisocyanate, toluene-2,6-diisocyanate, xylene-2,4-diisocyanate, xylene-2,6-diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene-bis(4-phenyl isocyanate), 2,2′-oxydiphenyl diisocyanate, 3,3′-oxydiphenyl diisocyanate, 4,4′-oxydiphenyl diisocyanate, 2,2′-diphenylsulfone diisocyanate, 3,3′-diphenylsulfone diisocyanate, 4,4′-diphenylsulfone diisocyanate, 2,2,-methylene-bis(cyclohexyl isocyanate), 3,3′-methylene-bis(cyclohexyl isocyanate), 4,4′-methylene-bis(cyclohexyl isocyanate), bis(para-isocyano-cyclohexyl)ether, 1,4-diisocyanato cyclohexane, OCN(CH₂)₃O(CH₂)₂O(CH₂)₃NCO, OCN(CH₂)₃N(CH₃)(CH₂)₃NCO, triphenylmethane-4,4′,4″-triisocyanate, toluene-2,4,6-triyl triisocyanate, ethyl ester 1-lysine triisocyanate, 1,6,11-triisocyanatoundecane, 2,2-bis[[4-(isocyanatomethyl)phenyl]methyl]butyl n-[[4-(isocyanatomethyl)phenyl]methyl]carbamate, (2,4,6-trioxotriazine-1,3,5(2h,4h,6h)-triyl)tris(hexamethylene) isocyanate, 1,3,5-triisocyanatobenzene, tris(isocyanatohexyl)biuret, 3,3′,3″-[(1h,3h,5h)-2,4,6-trioxo-1,3,5-triazine-1,3,5-triyltris(methylene)]tris[3,5,5-trimethylcyclohexyl] triisocyanate, 1,3,5-triazine-2,4,6 triisocyanate, 2,4,4′-triisocyanato-dicyclohexylmethane, triisocyanate triphenylthiophosphate, 2,4,4′-diphenylether triisocyanate and polymeric form of diisocyanates and triisocyanates; most preferably the at least one polyisocyanate (C) is selected from the group consisting of isophorone diisocyanate, hexamethylene-1,6-diisocyanate, 1,5-pentamethylene diisocyanate, octamethylene-1,8-diisocyanate, toluene-2,4-diisocyanate, toluene-2,6-diisocyanate, 2,2′-biphenylene diisocyanate, 3,3′-biphenylene diisocyanate, 4,4′-biphenylene diisocyanate, methylene-bis(4-phenyl isocyanate), 2,2,-methylene-bis(cyclohexyl isocyanate), 3,3′-methylene-bis(cyclohexyl isocyanate), 4,4′-methylene-bis(cyclohexyl isocyanate), bis(para-isocyano-cyclohexyl)ether, 1,4-diisocyanato cyclohexane, OCN(CH₂)₃O(CH₂)₂O(CH₂)₃NCO, OCN(CH₂)₃N(CH₃)(CH₂)₃NCO, triphenylmethane-4,4′,4″-triisocyanate, toluene-2,4,6-triyl triisocyanate, ethyl ester 1-lysine triisocyanate, 1,6,11-triisocyanatoundecane, 2,2-bis[[4-(isocyanatomethyl)phenyl]methyl]butyl n-[[4-(isocyanatomethyl)phenyl]methyl]carbamate, (2,4,6-trioxotriazine-1,3,5(2h,4h,6h)triyl)tris(hexamethylene) isocyanate, 1,3,5-triisocyanatobenzene, tris(isocyanatohexyl)biuret, 3,3′,3″-[(1h,3h,5h)-2,4,6-trioxo-1,3,5-triazine-1,3,5-triyltris(methylene)]tris[3,5,5-trimethylcyclohexyl] triisocyanate, 1,3,5-triazine-2,4,6-triisocyanate, 2,4,4′-triisocyanato-dicyclohexylmethane, triisocyanate triphenylthiophosphate, 2,4,4′-diphenylether triisocyanate and polymeric form of diisocyanates and triisocyanates; and in particular preferably the at least one polyisocyanate (C) is selected from the group consisting of isophorone diisocyanate, hexamethylene-1,6-diisocyanate, 1,5-pentamethylene diisocyanate, octamethylene-1,8-diisocyanate, toluene-2,4-diisocyanate, toluene-2,6-diisocyanate, 2,2′-biphenylene diisocyanate, 3,3′-biphenylene diisocyanate, 4,4′-biphenylene diisocyanate, methylene-bis(4-phenyl isocyanate), 2,2,-methylene-bis(cyclohexyl isocyanate), 3,3′-methylene-bis(cyclohexyl isocyanate), 4,4′-methylene-bis(cyclohexyl isocyanate), 1,4-diisocyanato cyclohexane, triphenylmethane-4,4′,4″-triisocyanate, toluene-2,4,6-triyl triisocyanate, (2,4,6-trioxotriazine-1,3,5(2h,4h,6h)-triyl)tris(hexamethylene) isocyanate, 1,3,5-triisocyanatobenzene, 1,3,5-triazine-2,4,6-triisocyanate, 2,4,4′-triisocyanato-dicyclohexylmethane, triisocyanate triphenylthiophosphate, 2,4,4′-diphenylether triisocyanate and polymeric form of diisocyanates and triisocyanates.

In another preferred embodiment, the at least one polyisocyanate (C) is selected from the group consisting of isophorone diisocyanate, hexamethylene-1,6-diisocyanate, 1,5-pentamethylene diisocyanate, meta-phenylene diisocyanate, para-phenylene diisocyanate, toluene-2,4-diisocyanate, toluene-2,6-diisocyanate, xylene-2,4-diisocyanate, xylene-2,6-diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylenebis(4-phenyl isocyanate), 2,2,-methylene-bis(cyclohexyl isocyanate), 3,3′-methylenebis(cyclohexyl isocyanate), 4,4′-methylene-bis(cyclohexyl isocyanate), triphenylmethane-4,4′,4″-triisocyanate, toluene-2,4,6-triyl triisocyanate, 1,3,5-triisocyanatobenzene and polymeric form of diisocyanates and triisocyanates.

In another preferred embodiment, the polymeric form of diisocyanates and triisocyanates denotes the isocyanates exist in dimeric, trimeric and oligomeric structure.

In another preferred embodiment, the at least one polyisocyanate (C) is present in the form of dimer, trimer and oligomers containing a urethane group, an isocyanurate group, a biuret group, an uretdione group, an allophanate group and/or an iminooxadiazinedione group.

In another preferred embodiment, the polyisocyanate (C) has an average NCO functionality in the range of ≥2.0 to ≤6.0; more preferably the polyisocyanate (C) has an average NCO functionality in the range of ≥2.0 to ≤5.0; even more preferably the polyisocyanate (C) has an average NCO functionality in the range of ≥2.0 to ≤4.5; and most preferably the polyisocyanate (C) has an average NCO functionality in the range of ≥2.0 to ≤4.0; and in particular the polyisocyanate (C) has an average NCO functionality in the range of ≥2.0 to ≤3.0.

### Step c.

c. reacting the at least one component (A) with the at least one secondary amine of formula (B) to obtain a first reaction product (D).

In another preferred embodiment, the step c. is conducted at a temperature in the range of 20 to 300° C., preferably the step is conducted at a temperature in the range of 50 to 300° C., more preferably the step is conducted at a temperature in the range of 80 to 250° C., even more preferably the step is conducted at a temperature in the range of 100 to 250° C., most preferably the step is conducted at a temperature in the range of 120 to 200° C., and in particular preferably the step is conducted at a temperature in the range of 140 to 180° C.

In another preferred embodiment, the step c. is conducted at a pressure in the range of 0.5 to 100 bar abs., preferably 1.0 to 80 bar abs., more preferably 1.0 to 50 bar abs., even more preferably 1.0 to 25 bar abs., most preferably 1.0 to 10 bar abs. and in particular 1.0 to 5.0 bar abs.

The products formed in step c. include, but are not limited to, oligomeric urethane, oligomeric urea, oligomeric urea-urethane, bis-urea, hydroxyl-groups-containing diols and/or polyols and amino-group-containing compounds. The products formed in step c. depend on the material that is used in step a. For example, if the material provided in step a. is polyurea then the reaction products obtained in step c. include, but are not limited to, oligomeric urea, bis-urea, and amino-group containing compounds.

Depending on the viscosity of the reaction mixture employed in Step c., the reaction can be carried out without a solvent or within an inert solvent.

An inert solvent is a solvent which does not react with the starting materials, reactants and/or the products obtained by the inventive process.

Preferably step c. is carried out without an inert solvent.

In case step c. is carried out within an inert solvent, the inert solvent is preferably selected from the group consisting of ethers, esters and aliphatic-, cyclo-aliphatic- and aromatic-hydrocarbons, as well as chlorinated aliphatic- and chlorinated aromatic-hydrocarbons.

Most preferably the step c. reaction is carried without a solvent.

Ethers are preferably selected from the group consisting of methyl-t-butyl ether, dibutyl ether, ethylene glycol dimethyl ether, tetrahydrofuran and dioxane.

Esters are preferably selected from the group consisting of methyl formate, acetic ester, and butyl ester.

The hydrocarbons are preferably selected from the group consisting of ligroin, petroleum ether, cyclohexane, methylcyclohexane, toluene, xylene, acetonitrile, benzonitrile, nitromethane, nitrobenzene, and benzene.

The chlorinated hydrocarbons are preferably selected from the group consisting of methylene chloride, chloroform, carbon tetrachloride, chlorobenzene, 1,2 dichlorobenzene, methyl chloroform, and perchlortetraethylene.

### Step e.

e. reacting the first reaction product (D) obtained in step c. with at least one polyisocyanate component (C) to obtain a product.

In another preferred embodiment, the step d. is conducted at a temperature in the range of 0 to 200° C., preferably the step is conducted at a temperature in the range of 20 to 120° C., more preferably the step is conducted at a temperature in the range of 20 to 100° C., even more preferably the step is conducted at a temperature in the range of 25 to 100° C., and most preferably the step is conducted at a temperature in the range of 30 to 80° C.

In another preferred embodiment, the step d. at atmospheric pressure.

In another preferred embodiment, the step d. reaction is carried without a solvent or within an inert solvent, most preferably the step d. reaction is carried in presence of a solvent.

In another preferred embodiment, the solvent selected from the group consisting of ketones, esters, aromatic solvents, aliphatic solvents, ethers, lactones, carbonates, sulfones, N,N-dimethylformamide, N,N-dimethylacetamide, acetonitrile, dimethylsulfoxide, N-methyl-pyrrolidone and N-ethyl-pyrrolidone, as well as chlorinated aliphatic and aromatic hydrocarbons.

In another preferred embodiment, the ether solvent is selected from the group consisting of methyl-t-butyl ether, dibutyl ether, ethylene glycol dimethyl ether, tetrahydrofuran and dioxane.

In another preferred embodiment, the ester solvent is selected from the group consisting of methyl formate, acetic ester, and butyl ester.

In another preferred embodiment, the hydrocarbon solvent is selected from the group consisting of ligroin, petroleum ether, cyclohexane, methylcyclohexane, toluene, xylene, acetonitrile, benzonitrile, nitromethane, nitrobenzene, and benzene.

In another preferred embodiment, the chlorinated hydrocarbons the following examples are specified: methylene chloride, chloroform, carbon tetrachloride, chlorobenzene, 1,2 dichlorobenzene, methyl chloroform, and perchlortetraethylene.

In another preferred embodiment, the molar ratio of NCO of the total amount of polyisocyanate compounds (C) provided in step d. to —NH— of the total amount of secondary amines of formula (B) provided in step c. is in the range of ≥1.0:10 to ≤10:1.0, more preferably the molar ratio of NCO of the total amount of polyisocyanate compounds (C) provided in step d. to —NH— of the total amount of secondary amines of formula (B) provided in step c. is in the range of ≥1.0:2.0 to ≤2.0:1.0; and most preferably the molar ratio of NCO of the total amount of polyisocyanate compounds (C) provided in step d. to —NH— of the total amount of secondary amines of formula (B) provided in step c. is in the range of ≥1.0:0.5 to ≤0.5:1.0.

In another embodiment, the presently claimed invention is directed to a polymer obtained in step e.

In another preferred embodiment, the product obtained in step e. has a weight average molecular weight Mw in the range of 500 g/mol to 5,00,000 g/mol, determined according to the DIN 55672; more preferably the product obtained in step e. has a weight average molecular weight Mw in the range of 1000 g/mol to 2,00,000 g/mol, determined according to the DIN 55672; even more preferably the product obtained in step e. has a weight average molecular weight Mw in the range of 2000 g/mol to 1,00,000 g/mol, determined according to the DIN 55672; most preferably the product obtained in step e. has a weight average molecular weight Mw in the range of 3000 g/mol to 80,000 g/mol, determined according to the DIN 55672; and in particular the product obtained in step e. has a weight average molecular weight Mw in the range of 5000 g/mol to 50,000 g/mol, determined according to the DIN 55672.

In another preferred embodiment, the product obtained in step e. has a glass transition temperature in the range of −20° C. to ≤250° C., determined according to ASTM D 3418 using a heating rate of 5 K/min; more preferably the product obtained in step e. has a glass transition temperature in the range of ≥0° C. to ≤200° C., determined according to ASTM D 3418 using a heating rate of 5 K/min; even more preferably the product obtained in step e. has a glass transition temperature in the range of ≥0° C. to ≤180° C., determined according to ASTM D 3418 using a heating rate of 5 K/min; most preferably the product obtained in step e. has a glass transition temperature in the range of ≥20° C. to ≤160° C., determined according to ASTM D 3418 using a heating rate of 5 K/min; and in particular the product obtained in step e. has a glass transition temperature in the range of ≥40° C. to ≤150° C., determined according to ASTM D 3418 using a heating rate of 5 K/min.

In another embodiment, the presently claimed invention is directed to an article comprising a copolymer obtained in step e.

In another preferred embodiment, the articles comprise a copolymer obtained in step e. and a polyurethane or a polyurea or polyurethane-urea polymer.

In another preferred embodiment, the articles comprise a copolymer obtained in step e. is present in an amount in the range of ≥1.0 to ≤99 and a polyurethane is present in an amount in the range of ≥99 to ≤1.0.

In another preferred embodiment, the articles comprise a copolymer obtained in step e. is present in an amount in the range of ≥1.0 to ≤99 and a polyurea is present in an amount in the range of ≥99 to ≤1.0.

In another preferred embodiment, the articles comprise a copolymer obtained in step e. is present in an amount in the range of ≥1.0 to ≤99 and a polyurethane-urea present is in an amount in the range of ≥99 to ≤1.0.

In another preferred embodiment, the articles comprise a copolymer obtained in step e. present in an amount in the range of ≥1.0 to ≤99 and at least one selected from the group consisting of polyurethane, polyurea and polyurethane-urea is present in an amount in the range of ≥99 to ≤1.0.

In another preferred embodiment, the polyurethane, polyurea and polyurethane-urea is present in an amount in the range of ≥99 to ≤1.0 is freshly prepared and or not used before for preparing any article.

In another preferred embodiment the article includes coatings, healable coatings, recyclable rigid foams, recyclable flexible foams, parts for the automotive industry, recyclable rigid foams, rigid foam insulation, durable elastomeric wheels and tires, adhesives, surface coatings and surface sealants, synthetic fibers, carpet underlay, hard-plastic parts

In another embodiment, the presently claimed invention is directed to a process for reshaping a copolymer comprising at least the steps of:
a) applying pressure and heat to the copolymer obtained step e. or the article comprising a copolymer obtained in step e. to obtain a heated copolymer; and
b) shaping the copolymer of step a).

In another preferred embodiment, the process comprises a step of:
a1. adding at least one polyurethane, polyurea and polyurethane-urea in an amount in the range of ≥99 to ≤1.0 to step a.

In another preferred embodiment, the pressure is the range of ≥5×10³ Pa to ≤10⁷ Pa.

In another preferred embodiment, the temperature is the range of ≥60° C. to ≤300° C.

The presently claimed invention is associated with at least one of the following advantages:
(i) provide a process for processing polyurea, polyurethane and polyurea-urethane polymer without losing the quality.
(ii) The articles prepared from the processed polyurethane, polyurea and polyurethane-urea polymer are similar in quality compared to the article prepared from freshly prepared polyurethane, polyurea and polyurethane-urea polymer.

### EMBODIMENTS

1. A process for treating polyurethane, polyurea and/or polyurethane-polyurea co polymers comprising the steps of:
a. providing at least one component (A) selected from the group consisting of polyurethane, polyurea and polyurethane-polyurea copolymers; and
b. providing at least one secondary amine of formula (B)

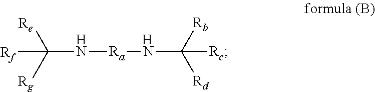

wherein Rₐ is selected from the group consisting of substituted or unsubstituted, linear or branched C₁-C₃₀ alkylene, substituted or unsubstituted, linear or branched 2- to 30-membered heteroalkylene, substituted or unsubstituted, linear or branched C₂-C₃₀ alkenylene, substituted or unsubstituted, linear or branched 3- to 30-membered heteroalkenylene, substituted or unsubstituted C₅-C₃₀ cycloalkylene, substituted or unsubstituted 5- to 30-membered heterocycloalkylene, substituted or unsubstituted C₅-C₃₀ cycloalkenylene, substituted or unsubstituted 5- to 30-membered heterocycloalkenylene, substituted or unsubstituted C₆-C₃₀ arylene, substituted or unsubstituted 5- to 30-membered heteroarylene, substituted or unsubstituted C₁-C₃₀ alkylene C₅-C₃₀ cycloalkylene, substituted or unsubstituted C₅-C₃₀ cycloalkylene C₁-C₃₀ alkylene C₅-C₃₀ cycloalkylene, substituted or unsubstituted C₁-C₃₀ alkylene 5- to 30-membered heterocycloalkylene, substituted or unsubstituted C₁-C₃₀ alkylene C₅-C₃₀ cycloalkenylene, substituted or unsubstituted C₁-C₃₀ alkylene 5- to 30-membered heterocycloalkenylene, substituted or unsubstituted C₁-C₃₀ alkylene C₆-C₃₀ arylene, substituted or unsubstituted C₆-C₃₀ arylene C₁-C₃₀ alkylene C₆-C₃₀ arylene, substituted or unsubstituted C₁-C₃₀ alkylene 5- to 30-membered heteroarylene, substituted or unsubstituted C₂-C₃₀ alkenylene C₅-C₃₀ cycloalkylene, substituted or unsubstituted C₂-C₃₀ alkenylene 5- to 30-membered heterocycloalkylene, substituted or unsubstituted C₂-C₃₀ alkenylene C₅-C₃₀ cycloalkenylene, substituted or unsubstituted C₂-C₃₀ alkenylene 5- to 30-membered heterocycloalkenylene, substituted or unsubstituted C₂-C₃₀ alkenylene C₆-C₃₀ arylene, and substituted or unsubstituted C₂-C₃₀ alkenylene 5- to 30-membered heteroarylene,
R_{b}, R_{c}, R_{d}, Rₑ, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, unsaturated or aromatic, unsubstituted or substituted 5- to 30-membered carbocyclic ring that contains 0, 1, 2 or 3 heteroatom(s) selected from O, N or S as ring member(s);
c. reacting the at least one component (A) with the at least one secondary amine of formula (B) to obtain a first reaction product (D);
d. proving at least one polyisocyanate component (C);
e. reacting the first reaction product (D) obtained in step c. with the at least one polyisocyanate component (C) to obtain a product,
   wherein the at least one polyisocyanate component (C) has an average NCO functionality of ≥2.0.
2. The process according to the embodiment 1, wherein the at least one polyisocyanate component (C) has an average NCO functionality in the range of ≥2.0 to ≤6.0.
3. The process according to embodiment 1, wherein the at least one polyisocyanate component (C) is selected from the group consisting of isophorone diisocyanate, propylene-1,2-diisocyanate, propylene-1,3-diisocyanate, butylene-1,2-diisocyanate, butylene-1,3-diisocyanate, hexamethylene-1,6-diisocyanate, 2-methylpentamethylene-1,5-diisocyanate, 2-ethylbutylene-1,4-diisocyanate, 1,5-pentamethylene diisocyanate, methyl-2,6-diisocyanate caproate, octamethylene-1,8-diisocyanate, 2,4,4-trimethylhexamethylene-1,6-diisocyanate, nonamethylene diisocyanate, 2,2,4-trimethylhexamethylene-1,6-diisocyanate, decamethylene-1,10-diisocyanate, 2,11-diisocyanato-dodecane, meta-phenylene diisocyanate, para-phenylene diisocyanate, toluene-2,4-diisocyanate, toluene-2,6-diisocyanate, xylene-2,4-diisocyanate, xylene-2,6-diisocyanate, methylpropylbenzene diisocyanate, methylethylbenzene diisocyanate, 2,2′-biphenylene diisocyanate, 3,3′-bi phenylene diisocyanate, 4,4′-biphenylene diisocyanate, 3,3′-dimethyl-4,4′-bi phenylene diisocyanate, methylene-bis(4-phenyl isocyanate), ethylene-bis(4-phenyl isocyanate), isopropylidene-bis(4-phenyl isocyanate), butylene-bis(4-phenylisocyanate), 2,2′-oxydiphenyl diisocyanate, 3,3′-oxydiphenyl diisocyanate, 4,4′-oxydiphenyl diisocyanate, 2,2′-ketodiphenyl diisocyanate, 3,3′-ketodiphenyl diisocyanate, 4,4′-ketodiphenyl diisocyanate, 2,2′-mercaptodiphenyl diisocyanate, 3,3′-mercaptodiphenyl diisocyanate, 4,4′-thiodiphenyl diisocyanate, 2,2′-diphenylsulfone diisocyanate, 3,3′-diphenylsulfone diisocyanate, 4,4′-diphenylsulfone diisocyanate, 2,2,-methylene-bis(cyclohexyl isocyanate), 3,3′-methylene-bis(cyclo hexyl isocyanate), 4,4′-methylene-bis(cyclohexyl isocyanate), 4,4′-ethylene-bis(cyclohexyl isocyanate), 4,4′-propylene-bis-(cyclohexyl isocyanate), bis(para-isocyano-cyclohexyl)sulfide, bis(para-isocyanato-cyclohexyl)sulfone, bis(para-isocyano-cyclohexyl)ether, bis(para-isocyanato-cyclohexyl)diethyl silane, bis(paraisocyanato-cyclohexyl)diphenyl silane, bis(para-isocyanato-cyclohexyl)ethyl phosphine oxide, bis(para-isocyanato-cyclohexyl)phenyl phosphine oxide, bis(para-iso cyanato-cyclohexyl)N-phenyl amine, bis(para-isocyanato-cyclohexyl)N-methyl amine, 3,3′-dimethyl-4,4′-diisocyano biphenyl, 3,3′-dimethoxy-biphenylene diisocyanate, 2, 4-bis(b-isocyanato-t-butyl)toluene, bis(para-b-isocyanato-t-butyl-phenyl)ether, para-bis(2-methyl-4-isocyanatophenyl) benzene, 3,3-diisocyanato adamantane, 3,3-diisocyano biadamantane, 3,3-diiso-cyanatoethyl-1′-biadamantane, 1,2-bis (3-isocyanato-propoxy)ethane, 2,2-dimethyl propylene diisocyanate, 3-methoxy hexamethylene-1,6-diisocyanate, 2,5-dimethyl heptamethylene diisocyanate, 5-methyl nonamethylene-1,9-diisocyanate, 1,4-diisocyanato cyclohexane, 1,2-diisocyanato octadecane, 2,5-diisocyanato-1,3,4-oxadiazole, OCN(CH₂)₃O(CH₂)₂O(CH₂)₃NCO, OCH(CH₂)₃N(CH₃)(CH₂)₃NCO, triphenylmethane-4,4′,4″-triisocyanate, toluene-2,4,6-triyl triisocyanate, ethyl ester 1-lysine triisocyanate, 1,6,11-triisocyanatoundecane, 2,2-bis[[4-(isocyanatomethyl)phenyl]methyl]butyl n-[[4-(isocyanatomethyl)phenyl]methyl]carbamate, (2,4,6-trioxotriazine-1,3,5(2h,4h,6h)-triyl)tris(hexamethylene) isocyanate, 1,3,5-triisocyanatobenzene, tris(isocyanatohexyl)biuret, 3,3′,3″-[(1h,3h,5h)-2,4,6-trioxo-1,3,5-triazine-1,3,5-triyltris(methylene)]tris[3,5,5-trimethylcyclohexyl] triisocyanate, 1,3,5-triazine-2,4,6-triisocyanate, 2,4,4′-triisocyanato-dicyclohexylmethane, triisocyanate triphenylthiophosphate, 2,4,4′-diphenylether triisocyanate and polymeric form of diisocyanates and triisocyanates.
4. The process according to any one of embodiments 1 to 3, wherein the at least one polyisocyanate component (C) is selected from the group consisting of isophorone diisocyanate, hexamethylene-1,6-diisocyanate, 1,5-pentamethylene diisocyanate, meta-phenylene diisocyanate, para-phenylene diisocyanate, toluene-2,4-diisocyanate, toluene-2,6-diisocyanate, xylene-2,4-diisocyanate, xylene-2,6-diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene-bis(4-phenyl isocyanate), 2,2,-methylene-bis(cyclohexyl isocyanate), 3,3′-methylenebis(cyclohexyl isocyanate), 4,4′-methylene-bis(cyclohexyl isocyanate), triphenyl methane-4,4′,4″-triisocyanate, toluene-2,4,6-triyl triisocyanate, 1,3,5-triisocyanatobenzene and polymeric form of diisocyanates and triisocyanates.
5. The process according to any one of the embodiments 1 to 4, wherein the at least one polyisocyanate component (C) is present in the form of a dimer, a trimer or an oligomer containing a urethane group, an isocyanurate group, a biuret group, an uretdione group, an allophanate group and/or an iminooxadiazinedione group.
6. The process according to any one of the embodiments 1 to 5, wherein the secondary amine of formula (B) is selected from the group consisting of N1,N3-diiso propyl-4-methyl-cyclohexane-1,3-diamine, 4-methyl-N1,N3-disec-butyl-cyclohexane-1,3-diamine, 2-methyl-N1,N3-disec-butyl-cyclohexane-1,3-diamine, N1,N3-dibenzyl-2-methyl-cyclohexane-1,3-diamine, N1,N3-dibenzyl-4-methyl-cyclohexane-1,3-diamine, N1,N3-bis(2-ethylhexyl)-4-methyl-cyclohexane-1,3-diamine, N-isopropyl-3-[(isopropylamino)methyl]-3,5,5-trimethyl-cyclohexanamine, N-sec-butyl-4-[[4-(sec-butylamino)phenyl]methyl]aniline, N,N′-bis(2,2,6,6-tetramethyl-4-piperidyl)hexane-1,6-diamine, N,N′-diethyl-2-butene-1,4-diamine, N,N-diiso propyl-1,3-propanediamine, N,N′-diisopropylethylenediamine, N,N′-dimethyl-1,3-propanediamine, 1,4,8,11-tetraazacyclotetradecane-5,7-dione, 1,4-diazacycloheptane, 1,2-dimethylethylenediamine, 1,2-diisopropylethylenediamine, N-(pyrrolidin-2-ylmethyl)cyclohexanamine, N-(pyrrolidin-2-ylmethyl)cycloheptanamine and 2-methyl-N-(pyrrolidin-2-ylmethyl)propan-2-amine.
7. The process according to any one of the embodiments 1 to 6, wherein the molar ratio of NCO of the total amount of polyisocyanate compounds (C) provided in step d. to —NH— of the total amount of secondary amines of formula (B) provided in step c. is in the range of ≥1.0:10 to ≤10:1.0.
8. The process according to any one of the embodiments 1 to 6, wherein the molar ratio of NCO of the total amount of polyisocyanate compounds (C) provided in step d. to —NH— of the total amount of secondary amines of formula (B) provided in step c. is in the range of ≥1.0:2.0 to ≤2.0:1.0.
9. The process according to any one of the embodiments 1 to 7, wherein the molar ratio of NCO of the total amount of polyisocyanate compounds (C) provided in step d. to —NH— of the total amount of secondary amines of formula (B) provided in step c. is in the range of ≥1.0:0.5 to ≤0.5:1.0.
10. The process according to any one of embodiments 1 to 9, wherein step c. is carried out at a temperature in the range of ≥−50° C. to ≤250° C.
11. The process according to any one of the embodiments 1 to 10, wherein step e. is carried out in the presence of at least one solvent.
12. The process according to embodiment 11, wherein the at least one solvent is selected from the group consisting of the at least one solvent is selected from the group consisting of ketones, esters, aromatic solvents, aliphatic solvents, ethers, lactones, carbonates, sulfones, N,N-dimethylformamide, N,N-dimethylacetamide, acetonitrile, dimethylsulfoxide, N-methyl-pyrrolidone and N-ethyl-pyrrolidone.
13. A copolymer obtained according to any of the embodiments 1 to 12.
14. The copolymer according to embodiment 13, wherein the copolymer has a glass transition temperature in the range of ≥−20° C. to ≤250° C., to ASTM D 3418 using a heating rate of 5 K/min.
15. An article comprising a copolymer according to any one of embodiments 13 to 14.
16. A process for reshaping a copolymer comprising at least the steps of:
a) applying pressure and heat to the copolymer obtained according to the process of any one of embodiments 1 to 12 or the copolymer according to any one of embodiments 13 to 14 or the article according to embodiment 15 to obtain a heated co polymer; and
b) shaping the copolymer of step a).
17. The process according to embodiment 16, wherein the pressure is the range of 5×10³ Pa to ≤10⁷ Pa.
18. The process according to embodiment 16 or 17, wherein the temperature is the range of ≥60° C. to ≤300° C.

While the presently claimed invention has been described in terms of its specific embodiments, certain modifications and equivalents will be apparent to those skilled in the art and are intended to be included within the scope of the presently claimed invention

### EXAMPLES

### Materials

PMDI: Polymeric diphenylmethane diisocyanate.

DIB-MDA: N-sec-butyl-4-[[4-(sec-butylamino)phenyl]methyl]aniline.

### Example 1

### Step 1: Synthesis of the Polymer

Polymeric methylene diphenylisocyanate (pMDI, Lupranat M20FB) (16.52 g, f=2.53) and THF (250 g) were charged in a round-bottom flask equipped with stirrer, thermometer, and nitrogen inlet and cooled using an ice bath under nitrogen atmosphere. A sterically hindered secondary diamine, DIB-MDA (N-secbutyl-4-[[4-(sec-butylamino) phenyl]methyl]aniline) (19.02 g) in 50 g of THF was slowly added in order to form a polyurea. After stirring for 1 hour, the reaction mixture was warmed to room temperature. The reaction mixture was heated to 60° C. and stirring was continued until polymerization was complete, which was confirmed by IR spectroscopy (disappearance of the NCO band). THF was evaporated under reduced pressure. The resulting material was crushed and dried under reduced pressure at elevated temperature to remove residual traces of THF. The product was obtained as a slightly yellowish solid in quantitative yield.

### Step 2: Obtaining an Article

In order to obtain usable articles, the resulting powder from step 1 was then put on a hot press (180° C., 20 kN) und reshaped for 5 minutes. The powder was reshaped to a solid, round plate (P1).

### Step 3: Recycling of the Solid Plate (According to Present Invention)

The plate P1 was cut into small pieces (approx. 4 mm²). 10 g of DIB-MDA (N-secbutyl-4-[[4-(sec-butylamino)phenyl]methyl]aniline) were placed in a 100 mL round-bottom flask equipped with stirrer, thermometer, and nitrogen inlet. 1 g of the small cut pieces of P1 was added and the mixture was heated to 130° C. inside temperature using an oil bath (bath temperature 135-140° C.). As soon as the reaction was complete and the plate piece had completely dissolved, another 1 g of P1 was added, and the mixture was stirred. This process was repeated until 6 g of P1 had been added and a completely homogenous brown liquid had been obtained (LIQ1). This brown liquid was then cooled to room temperature and the amine number was determined.

The amine number in this example was 238.3 mg KOH/g.

### Step 4: Using the Recycling Liquid LIQ1 to Produce a Fresh Polymer

The amine number of 10 g of the LIQ1 is 238.3 g KOH/g.

Polymeric methylene diphenylisocyanate (pMDI, Lupranat M20FB) (5.665 g, f=2.53) and THF (125 g) were charged in a round-bottom flask equipped with stirrer, thermometer, and nitrogen inlet. The recycling liquid LIQ1 (10 g) was diluted in approx. 35 mL of THF and then slowly added to the flask under nitrogen atmosphere in order to form a polyurea. The reaction mixture was heated to 60° C. and stirring was continued until polymerization was complete, which was confirmed by IR spectroscopy (disappearance of the NCO band). THF was evaporated under reduced pressure. The resulting material was crushed and dried under reduced pressure at elevated temperature to remove residual traces of THF. The product was obtained as a slightly yellowish solid in quantitative yield.

### Step 5: Obtaining an Article

In order to obtain usable articles, the resulting powder was then put on a hot press (180° C., 20 kN) and reshaped for 5 minutes. The powder was reshaped to a solid, round plate (P2).

Material Data for P1 and P2

| Product | E-Modulus | ε_{M} [%] | σ_{M} [MPa] | ε_{B} [%] Min Max | | | σ_{B} [MPa] | a_{B} [J/cm³] |
|---|---|---|---|---|---|---|---|---|
| P1 | 1962 ± 215 | 4.3 ± 0.5 | 56.7 ± 1.1 | 4.1 | 3.9 | 4.4 | 56.2 ± 0.8 | 1.35 ± 0.11 |
| P2 | 2320 ± 231 | 3.5 ± 0.7 | 57.9 ± 6.0 | 3.5 | 2.6 | 4.8 | 57.8 ± 6.0 | 1.20 ± 0.44 |

ε_{M}-Elongation measured in accordance to DIN EN ISO 527-2
σ_{M}-tensile strength measured in accordance to DIN EN ISO 527-2
ε_{B}-Elongation at break measured in accordance to DIN EN ISO 527-2
σ_{B}-Fracture stress measured in accordance to DIN EN ISO 527-2
a_{B}-Fracture toughness measured in accordance to DIN EN ISO 527-2

The presently claimed invention provides a process for processing polyurea, polyurethane and polyurea-urethane polymer. It is evident for the examples that the articles prepared using the processed product displays similar physical properties compared to the fresh polymer.

1.-17. (canceled)

18. A process for treating polyurethane, polyurea and/or polyurethane-polyurea copolymers comprising the steps of:
a) providing at least one component (A) selected from the group consisting of polyurethane, polyurea and polyurethane-polyurea copolymers; and
b) providing at least one secondary amine of formula (B) 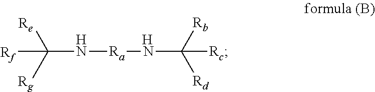
wherein Rₐ is selected from the group consisting of substituted or unsubstituted, linear or branched C₁-C₃₀ alkylene, substituted or unsubstituted, linear or branched 2- to 30-membered heteroalkylene,
substituted or unsubstituted, linear or branched C₂-C₃₀ alkenylene, substituted or unsubstituted, linear or branched 3- to 30-membered heteroalkenylene,
substituted or unsubstituted C₅-C₃₀ cycloalkylene,
substituted or unsubstituted 5- to 30-membered heterocycloalkylene, substituted or unsubstituted C₅-C₃₀ cycloalkenylene, substituted or unsubstituted 5- to 30-membered heterocycloalkenylene, substituted or unsubstituted C₆-C₃₀ arylene,
substituted or unsubstituted 5- to 30-membered heteroarylene, substituted or unsubstituted C₁-C₃₀ alkylene C₅-C₃₀ cycloalkylene, substituted or unsubstituted C₅-C₃₀ cycloalkylene C₁-C₃₀ alkylene C₅-C₃₀ cycloalkylene, substituted or unsubstituted C₁-C₃₀ alkylene 5- to 30-membered heterocycloalkylene,
substituted or unsubstituted C₁-C₃₀ alkylene C₅-C₃₀ cycloalkenylene,
substituted or unsubstituted C₁-C₃₀ alkylene 5- to 30-membered heterocycloalkenylene, substituted or unsubstituted C₁-C₃₀ alkylene C₆-C₃₀ arylene, substituted or unsubstituted C₆-C₃₀ arylene C₁-C₃₀ alkylene C₆-C₃₀ arylene, substituted or unsubstituted C₁-C₃₀ alkylene 5- to 30-membered heteroarylene, substituted or unsubstituted C₂-C₃₀ alkenylene C₅-C₃₀ cycloalkylene, substituted or unsubstituted C₂-C₃₀ alkenylene 5- to 30-membered heterocycloalkylene, substituted or unsubstituted C₂-C₃₀ alkenylene C₅-C₃₀ cycloalkenylene, substituted or unsubstituted C₂-C₃₀ alkenylene 5- to 30-membered heterocycloalkenylene, substituted or unsubstituted C₂-C₃₀ alkenylene C₆-C₃₀ arylene, and substituted or unsubstituted C₂-C₃₀ alkenylene 5- to 30-membered heteroarylene,
R_{b}, R_{c}, R_{d}, Rₑ, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl,
substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
Rₑ and R_{b} together with the carbon atoms to which they are bonded, or
R_{b} and Rₑ together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, unsaturated or aromatic, unsubstituted or substituted 5- to 30-membered carbocyclic ring that contains 0, 1, 2 or 3 heteroatom(s) selected from O, N or S as ring member(s);
c) reacting the at least one component (A) with the at least one secondary amine of formula (B) to obtain a first reaction product (D);
d) proving at least one polyisocyanate component (C);
e) reacting the first reaction product (D) obtained in step c. with the at least one polyisocyanate component (C) to obtain a product,
wherein the at least one polyisocyanate component (C) has an average NCO functionality of ≥2.0.

19. The process according to the claim 18, wherein the at least one polyisocyanate component (C) has an average NCO functionality in the range of ≥2.0 to ≤6.0.

20. The process according to claim 18, wherein the at least one polyisocyanate component (C) is selected from the group consisting of isophorone diisocyanate, propylene-1,2-diisocyanate, propylene-1,3-diisocyanate, butylene-1,2-diisocyanate, butylene-1,3-diisocyanate, hexamethylene-1,6-diisocyanate, 2-methylpentamethylene-1,5-diisocyanate, 2-ethylbutylene-1,4-diisocyanate, 1,5-pentamethylene diisocyanate, methyl-2,6-diisocyanate caproate, octamethylene-1,8-diisocyanate, 2,4,4-trimethylhexamethylene-1,6-diisocyanate, nonamethylene diisocyanate, 2,2,4-trimethylhexamethylene-1,6-diisocyanate, decamethylene-1,10-diisocyanate, 2,11-diisocyanato-dodecane, meta-phenylene diisocyanate, para-phenylene diisocyanate, toluene-2,4-diisocyanate, toluene-2,6-diisocyanate, xylene-2,4-diisocyanate, xylene-2,6-diisocyanate, methylpropylbenzene diisocyanate, methylethylbenzene diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene-bis(4-phenyl isocyanate), ethylenebis(4-phenyl isocyanate), isopropylidene-bis(4-phenyl isocyanate), butylene-bis(4-phenylisocyanate), 2,2′-oxydiphenyl diisocyanate, 3,3′-oxydiphenyl diisocyanate, 4,4′-oxydiphenyl diisocyanate, 2,2′-ketodiphenyl diisocyanate, 3,3′-ketodiphenyl diisocyanate, 4,4′-ketodiphenyl diisocyanate, 2,2′-mercaptodiphenyl diisocyanate, 3,3′-mercaptodiphenyl diisocyanate, 4,4′-thiodiphenyl diisocyanate, 2,2′-diphenylsulfone diisocyanate, 3,3′-diphenylsulfone diisocyanate, 4,4′-diphenylsulfone diisocyanate, 2,2,-methylene-bis(cyclohexyl isocyanate), 3,3′-methylene-bis(cyclohexyl isocyanate), 4,4′-methylene-bis(cyclohexyl isocyanate), 4,4′-ethylene-bis(cyclohexyl isocyanate), 4,4′-propylene-bis-(cyclohexyl isocyanate), bis(para-isocyano-cyclohexyl)sulfide, bis(para-isocyanato-cyclohexyl)sulfone, bis(para-isocyano-cyclohexyl)ether, bis(para-isocyanato-cyclohexyl)diethyl silane, bis(paraisocyanato-cyclohexyl)diphenyl silane, bis(para-isocyanato-cyclohexyl)ethyl phosphine oxide, bis(para-isocyanato-cyclohexyl)phenyl phosphine oxide, bis(para-isocyanato-cyclohexyl)N-phenyl amine, bis(para-isocyanato-cyclohexyl)N-methyl amine, 3,3′-dimethyl-4,4′-diisocyano biphenyl, 3,3′-dimethoxy-biphenylene diisocyanate, 2, 4-bis(b-isocyanato-t-butyl)toluene, bis(para-b-isocyanato-t-butyl-phenyl)ether, para-bis(2-methyl-4-isocyanatophenyl)benzene, 3,3-diisocyanato adamantane, 3,3-diisocyano biadamantane, 3,3-diiso-cyanatoethyl-1′-biadamantane, 1,2-bis (3-isocyanato-propoxy)ethane, 2,2-dimethyl propylene diisocyanate, 3-methoxy hexamethylene-1,6-diisocyanate, 2,5-dimethyl heptamethylene diisocyanate, 5-methyl nonamethylene-1,9-diisocyanate, 1,4-diisocyanato cyclohexane, 1,2-diisocyanato octadecane, 2,5-diisocyanato-1,3,4-oxadiazole, OCN(CH₂)₃O(CH₂O(CH₂)₃NCO, OCH(CH₂)₃N(CH₃)(CH₂)₃NCO, triphenylmethane-4,4′,4″-triisocyanate, toluene-2,4,6-triyl triisocyanate, ethyl ester 1-lysine triisocyanate, 1,6,11-triisocyanatoundecane, 2,2-bis[[4-(isocyanatomethyl)phenyl]methyl]butyl n-[[4-(isocyanatomethyl)phenyl]methyl]carbamate, (2,4,6-trioxotriazine-1,3,5(2h,4h,6h)-triyl)tris(hexamethylene) isocyanate, 1,3,5-triisocyanatobenzene, tris(isocyanatohexyl)biuret, 3,3′,3″-[(1h,3h,5h)-2,4,6-trioxo-1,3,5-triazine-1,3,5-triyltris(methylene)]tris[3,5,5-trimethylcyclohexyl] triisocyanate, 1,3,5-triazine-2,4,6-triisocyanate, 2,4,4′-triisocyanato-dicyclohexylmethane, triisocyanate triphenylthiophosphate, 2,4,4′-diphenylether triisocyanate and polymeric form of diisocyanates and triisocyanates.

21. The process according to claim 18, wherein the at least one polyisocyanate component (C) is selected from the group consisting of isophorone diisocyanate, hexamethylene-1,6-diisocyanate, 1,5-pentamethylene diisocyanate, meta-phenylene diisocyanate, para-phenylene diisocyanate, toluene-2,4-diisocyanate, toluene-2,6-diisocyanate, xylene-2,4-diisocyanate, xylene-2,6-diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene-bis(4-phenyl isocyanate), 2,2,-methylene-bis(cyclohexyl isocyanate), 3,3′-methylene-bis(cyclohexyl isocyanate), 4,4′-methylene-bis(cyclohexyl isocyanate), triphenylmethane-4,4′,4″-triisocyanate, toluene-2,4,6-triyl triisocyanate, 1,3,5-triisocyanatobenzene and polymeric form of diisocyanates and triisocyanates.

22. The process according to claim 18, wherein the at least one polyisocyanate component (C) is present in the form of a dimer, a trimer or an oligomer containing at least one urethane group, isocyanurate group, biuret group, uretdione group, allophanate group and/or iminooxadiazinedione group.

23. The process according to claim 18, wherein the secondary amine of formula (B) is selected from the group consisting of N1,N3-diisopropyl-4-methyl-cyclohexane-1,3-diamine, 4-methyl-N1,N3-disec-butyl-cyclohexane-1,3-diamine, 2-methyl-N1,N3-disec-butylcyclohexane-1,3-diamine, N1,N3-dibenzyl-2-methyl-cyclohexane-1,3-diamine, N1,N3-dibenzyl-4-methyl-cyclohexane-1,3-diamine, N1,N3-bis(2-ethylhexyl)-4-methyl-cyclohexane-1,3-diamine, N-isopropyl-3-[(isopropylamino)methyl]-3,5,5-trimethyl-cyclohexanamine, N-sec-butyl-4-[[4-(sec-butylamino)phenyl]methyl]aniline, N,N′-bis(2,2,6,6-tetramethyl-4-piperidyl)hexane-1,6-diamine, N,N-diethyl-2-butene-1,4-diamine, N,N-diisopropyl-1,3-propanediamine, N,N-diisopropylethylenediamine, N,N-dimethyl-1,3-propanediamine, 1,4,8,11-tetraazacyclotetradecane-5,7-dione, 1,4-diazacycloheptane, 1,2-dimethylethylenediamine, 1,2-diisopropylethylenediamine, N-(pyrrolidin-2-ylmethyl)cyclohexanamine, N-(pyrrolidin-2-ylmethyl)cycloheptanamine and 2-methyl-N-(pyrrolidin-2-ylmethyl)propan-2-amine.

24. The process according to claim 18, wherein the molar ratio of NCO of the total amount of polyisocyanate compounds (C) provided in step d. to —NH— of the total amount of secondary amines of formula (B) provided in step c. is in the range of ≥1.0:10 to ≤10:1.0.

25. The process according to claim 18, wherein the molar ratio of NCO of the total amount of polyisocyanate compounds (C) provided in step d. to —NH— of the total amount of secondary amines of formula (B) provided in step c. is in the range of ≥1.0:2.0 to ≤2.0:1.0.

26. The process according to claim 18, wherein the molar ratio of NCO of the total amount of polyisocyanate compounds (C) provided in step d. to —NH— of the total amount of secondary amines of formula (B) provided in step c. is in the range of ≥1.0:0.5 to ≤0.5:1.0.

27. The process according to claim 18, wherein step c. is carried out at a temperature in the range of ≥−50° C. to ≤250° C.

28. The process according to claim 18, wherein step e. is carried out in the presence of at least one solvent.

29. The process according to claim 28, wherein the at least one solvent is selected from the group consisting of the at least one solvent is selected from the group consisting of ketones, esters, aromatic solvents, aliphatic solvents, ethers, lactones, carbonates, sulfones, N,N-dimethylformamide, N,N-dimethylacetamide, acetonitrile, dimethylsulfoxide, N-methylpyrrolidone and N-ethyl-pyrrolidone.

30. A copolymer obtained according to claim 18.

31. An article comprising a copolymer according to claim 30.

32. A process for reshaping a copolymer comprising at least the steps of:
a) applying pressure and heat to the copolymer according to claim 30 to obtain a heated copolymer; and
b) shaping the copolymer of step a).

33. The process according to claim 32, wherein the pressure is the range of ≥5×10³ Pa to ≤10⁷ Pa.

34. The process according to claim 32, wherein the temperature is the range of ≥60° C. to ≤300° C.
